(19) United States
(12) Patent Application Publication
(10) Pub. No.: US 2024/0359478 A1
(43) Pub. Date: Oct. 31, 2024

(54) LIQUID STORAGE APPARATUS AND SYSTEM

(71) Applicant: CANON KABUSHIKI KAISHA, Tokyo (JP)

(72) Inventors: HIROMASA YONEYAMA, Kanagawa (JP); KENTA IIMURA, Kanagawa (JP); RYOHEI MARUYAMA, Kanagawa (JP); DAIGO KURONUMA, Kanagawa (JP); MASAKAZU NAGASHIMA, Kanagawa (JP); NAOAKI WADA, Kanagawa (JP); KICHINOSUKE HIROKAWA, Tokyo (JP); YUTO NITAMI, Kanagawa (JP); AKIRA FUJIKAKE, Kanagawa (JP); TOMOYUKI NAGASE, Kanagawa (JP); HIDEYUKI NOZAWA, Tochigi (JP)

(21) Appl. No.: 18/647,686

(22) Filed: Apr. 26, 2024

(30) Foreign Application Priority Data
Apr. 28, 2023 (JP) 2023-074956

(51) Int. Cl. B41J 2/175; B41J 2/21

(52) U.S. Cl. CPC B41J 2/17533; B41J 2/2103; B41J 2/17566; B41J 2002/17573

(57) ABSTRACT

A liquid storage apparatus includes storage portions arranged in a first direction, each storage portion configured to store a liquid container for storing a liquid, status display units, each status display unit corresponding to one of the storage portions and configured to display a status of the liquid container, and type display units, each type display unit corresponding to one of the storage portions and configured to display a type of liquid assigned to the storage portion. Each storage portion and the corresponding status display unit are arranged so as to be aligned in a second direction that intersects the first direction. The storage portion and the corresponding type display unit are arranged so as to be aligned in the second direction. The type display unit is arranged on a side of the status display unit with respect to the storage portion.

### BACKGROUND

### Field of the Disclosure

The present disclosure relates to a liquid supply apparatus and a system.

### Description of the Related Art

Liquid containers are known as a method of storing a liquid. Such liquid containers can be used as liquid containers for storing ink. International Publication No. 2017/217001 discloses an apparatus for printing an image by supplying ink from a bag-shaped ink container to a printing apparatus.

When an apparatus is configured such that a plurality of liquid containers can be used, the apparatus tends to increase in size, and thus, improvement thereof is required.

### SUMMARY

The present disclosure provides a technique for achieving downsizing of an apparatus while allowing a plurality of liquid containers to be stored.

According to one aspect of the present disclosure, there is provided a liquid storage apparatus comprising storage portions arranged in a first direction, each storage portion configured to store a liquid container for storing a liquid to be supplied to a discharge head; status display units, each status display unit corresponding to one of the storage portions and configured to display a status of the liquid container stored in the storage portion; and type display units, each type display unit corresponding to one of the storage portions and configured to display a type of liquid assigned to the storage portion, wherein each storage portion and the corresponding status display unit are arranged so as to be aligned in a second direction that intersects the first direction, and wherein the storage portion and the corresponding type display unit are arranged so as to be aligned in the second direction, and the type display unit is arranged on a side of the status display unit with respect to the storage portion.

Further features of the present disclosure will become apparent from the following description of exemplary embodiments (with reference to the attached drawings).

### BRIEF DESCRIPTION OF THE DRAWINGS

FIG. 1 is a perspective view of a system according to one embodiment of the present disclosure.

FIG. 2A is a front view of the system of FIG. 1.

FIG. 2B is an explanatory view illustrating an internal structure of a liquid discharge apparatus.

FIG. 3 is a partially exploded perspective view of a liquid supply apparatus.

FIG. 4 is a perspective view of a liquid container and a support unit.

FIGS. 5A and 5B are explanatory views of operation of a handle and a lock mechanism.

FIGS. 6A to 6C are explanatory views of operation of the lock mechanism.

FIG. 7 is a diagram illustrating a mounting orientation and insertion and removal states of support units with respect to slots.

FIG. 8 is an explanatory view of operation of a pressing unit.

FIG. 9 is an explanatory view of operation of the pressing unit.

FIGS. 10A and 10B are explanatory views of a cam.

FIG. 11 is a perspective view of a case with a mixing function and a support unit in a separated state.

FIG. 12 is a perspective view of a case with a mixing function and a support unit in a mounted state.

FIGS. 13A to 13C are explanatory views of a mixing operation.

FIG. 14A is a front view of the liquid supply apparatus.

FIG. 14B is a front view of another example of the liquid supply apparatus.

FIG. 15 is a block diagram of a control circuit of the system of FIG. 1.

FIGS. 16A and 16B are flowcharts for explaining an example of processing performed by a control unit of the liquid discharge apparatus.

FIGS. 17A and 17B are flowcharts for explaining an example of processing performed by the control unit of the liquid discharge apparatus.

FIGS. 18A and 18B are explanatory views of another example of the pressing member.

FIGS. 19A to 19C are explanatory views of another example of the pressing member.

FIGS. 20A to 20C are explanatory views of a pressing location with respect to the liquid container.

FIGS. 21A and 21B are views illustrating an example of another layout of the system of FIG. 1.

FIG. 22A and FIG. 22B are explanatory views of an example of another configuration of the handle.

FIGS. 23A and 23B are explanatory views of an example of another configuration of the handle.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

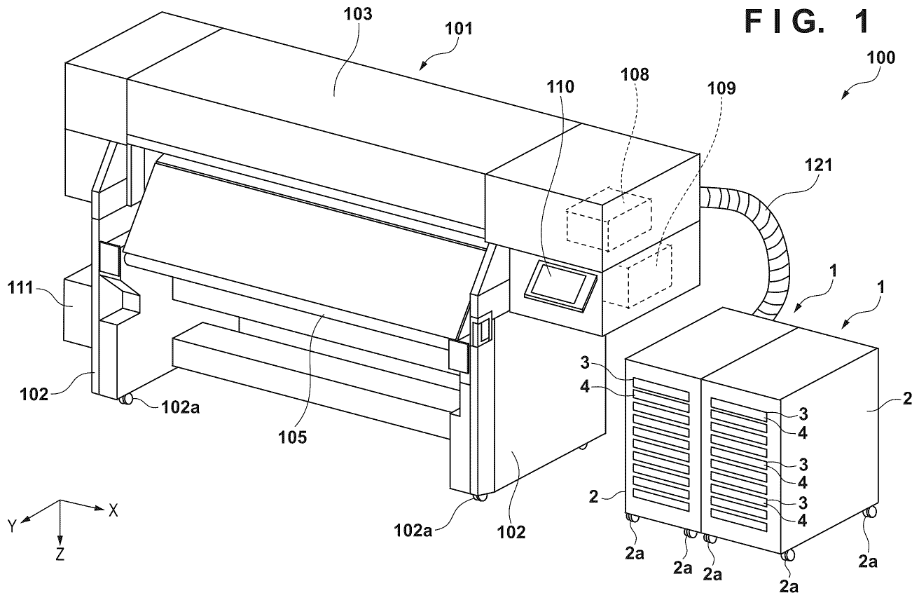

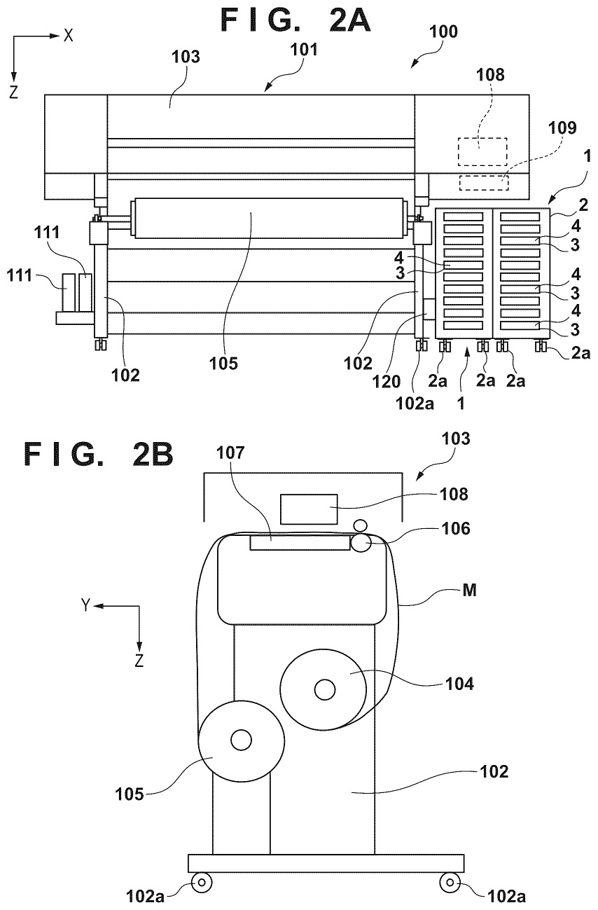

FIG. 1 is a perspective view of a system 100 according to one embodiment of the present disclosure, and FIG. 2A is a front view of the system 100. In each figure, arrows X, Y, and Z indicate directions intersecting each other and, in the case of the present embodiment, are orthogonal. Assume that a left-right direction when the system 100 is installed on a horizontal plane is an X direction, a front-back direction is a Y direction, and an up-down direction is a Z-direction. Further, assume that a right side when the system 100 is viewed from the front is a +X direction, a left side is a −X direction, a near side is a +Y direction, a far side is a −Y direction, a down side (downward in the direction of gravity) is a +Z direction, and an up side is a −Z direction.

The system 100 of the present embodiment is a printing system that includes liquid supply apparatuses 1 and a liquid discharge apparatus 101 and prints an image by discharging ink onto a printing medium, such as paper. The liquid supply apparatus 1 is a liquid storage apparatus in that it stores liquids. In the case of the present embodiment, a plurality of (here, two) liquid supply apparatuses 1 are provided so as to be connected to each other. The liquid discharge apparatus 101 and the two liquid supply apparatuses 1 are arranged so as to be aligned in the X direction. The liquid that the liquid supply apparatus 1 supplies to the liquid discharge apparatus 101 is ink, and the liquid discharge apparatus 101 is a printing apparatus that discharges ink onto a printing medium. However, the present disclosure is not limited to a printing system and is applicable to various types of liquid discharge systems for discharging a liquid onto a medium.

“Printing” includes not only cases of forming meaningful information, such as characters and shapes, but also cases of forming images, designs, patterns, and the like widely on a printing medium regardless of meaningfulness or of processing a medium, and it does not matter whether these are actualized so as to be visually perceivable by a human. In addition, although sheet-like paper is assumed as a “printing medium” in the present embodiment, it may be cloth, plastic film, or the like.

### <Liquid Discharge Apparatus>

The liquid discharge apparatus 101 will now be described with reference to FIG. 2B in addition to FIGS. 1 and 2A. FIG. 2B is an explanatory view of an internal structure of the liquid discharge apparatus 101. The liquid discharge apparatus 101 includes a pair of left and right stands 102 and a body 103 supported on the pair of stands 102. Each stand 102 is provided with casters 102a, and the liquid discharge apparatus 101 can be moved relatively easily on the floor. A feeding unit 104 and a winding unit 105 are arranged below the body 103. In the present embodiment, a printing medium M is rolled paper, and the feeding unit 104 includes a shaft on which the printing medium M is wound. The winding unit 105 includes a shaft for winding the printing medium M. In the case of the present embodiment, rolled paper is given as an example of the printing medium M, but it may be cut paper.

A conveyance unit 106 is provided in the body 103. The conveyance unit 106 includes a driving roller and a driven roller and sandwiches a printing medium M fed from the feeding unit 104 in a nip portion of the rollers. The printing medium M is conveyed on a platen 107 by rotation of the driving roller. A discharge head 108 is arranged so as to face the platen 107. The discharge head 108 is a printhead that discharges ink to form an image. An image is printed on the printing medium M conveyed on the platen 107 by the discharge head 108 discharging ink on the printing medium M.

The discharge head 108 includes, for example, discharge energy generation elements, such as electro-thermal conversion elements (heaters) or piezo elements, and discharges ink from a discharge port. When electro-thermal conversion elements are used, the heat thereof causes ink to bubble, and using the bubble energy thereof, ink can to be discharged from discharge ports. The printing method of the discharge head 108 may be a serial scan method or a full line method. In the case of the serial scan method, the discharge head 108 is mounted on a carriage and moves back and forth in the X direction. The discharge head 108 discharging ink while moving in the X direction is called print scanning. The conveyance operation of the printing medium M and the print scanning of the discharge head 108 are alternately repeated to print an image on the printing medium M. In the case of the present embodiment, assume that the serial scan method is employed. In the case of the full line method, a long discharge head 108 extending in the X direction is used, and an image is printed while continuously conveying the printing medium M.

The printing medium M on which an image has been printed is wound by the winding unit 105. The printing medium M on which an image has been printed is cut by a user using scissors or the like or is automatically cut by a cutter (not illustrated).

A recovery unit 109 is arranged in the body 103. The recovery unit 109 is arranged outside a printing region (outside a discharge region) of the discharge head 108 and performs processing related to recovery and maintenance of the discharge performance of the discharge head 108. For example, preliminary discharge in which a predetermined amount of ink is discharged before and after a printing operation or processing for suctioning remaining ink or the like from the discharge ports of the discharge head 108 can be given as such processing. The discharge head 108 is moved above the recovery unit 109 when the recovery processing is needed, as illustrated in FIG. 2A.

In the present embodiment, the stands 102 support the heavy feeding unit 104 and winding unit 105 while supporting the body 103 and thus are arranged at positions slightly outside the width of the printing medium M in the +X directions. In addition, the body 103 includes a portion protruding to an outer side in the +X direction than the stand 102, and the recovery unit 109 is arranged (incorporated) in the protruding portion. The body 103 also includes a portion protruding to an outer side of the printing medium M on the opposite, −X direction side. Here, a mechanism or the like for moving the carriage (not illustrated) on which the discharge head 108 is mounted is incorporated.

An operation panel 110 is provided on the front surface of the body 103. The operation panel 110 is, for example, a touch panel and can accept input of various settings related to printing, display the status of a print job, and the like.

The liquid discharge apparatus 101 is also provided with waste liquid cartridges 111. The waste liquid cartridges 111 are arranged below an end portion of the body 103 on a side (−X side) opposite to the liquid supply apparatus 1. By installing the waste liquid cartridges 111 below the portion of the body 103 protruding to the −X side, the installation area of the liquid discharge apparatus 101 can be reduced.

A waste liquid (waste ink or the like) suctioned by the recovery unit 109 flows into and is collected in the waste liquid cartridge 111. The waste liquid cartridges 111 may be arranged near the recovery unit 109. However, in the present embodiment, the waste liquid cartridges 111 are arranged in an empty space below the end portion of the body 103 to reduce the installation area of the liquid discharge apparatus 101.

### <Liquid Supply Apparatus>

FIGS. 1 and 2A are referred to. The liquid supply apparatus 1 is an apparatus for supplying ink to be discharged from the discharge head 108 to the liquid discharge apparatus 101. The liquid supply apparatus 1 includes a box-shaped body 2 in which a plurality of slots 3 are formed. Casters 2a are provided on the bottom surface of the body 2, and the liquid supply apparatus 1 can be moved relatively easily on the floor. The plurality of slots 3 are opened in an outer wall portion 2b on the front side of the body 2, and the plurality of slots 3 are arranged in the Z direction. The outer wall portion 2b forms the housing of the body 2. A support unit 4 is inserted in each slot 3 so as to be attachable and detachable. The support unit 4 supports a liquid container 200 (also simply referred to as a container 200) to be described later. Each slot 3 functions as a storage portion of the container 200.

Each slot 3 is provided with a tube for connecting the container 200 and the liquid discharge apparatus 101. Each tube is connected to the liquid discharge apparatus 101 through a single hose 121 storing all the tubes. The ink in the container 200 is supplied to the discharge head 108 via a tube.

The height of the liquid supply apparatus 1 is set to be lower than the bottom surface of the end portion of the body 103 protruding to the +X side of the liquid discharge apparatus 101. Therefore, as in FIG. 2A, the liquid supply apparatuses 1 can fit below a portion (portion in which the recovery unit 109 is incorporated) of the body 103 protruding in the +X direction and adjacent to the stand 102. The downsizing of the system 100 can be achieved. The liquid supply apparatuses 1 can be brought closer in the X direction up to a position at which they come into contact with the stand 102. As illustrated in FIG. 2A, the liquid supply apparatuses 1 may be secured to the stand 102, using a coupling member 120. When moving the system 100, the liquid discharge apparatus 101 and the liquid supply apparatuses 1 can be moved as a unit.

The system 100 of the present embodiment is provided with two liquid supply apparatuses 1 and thus can use more containers 200. When increasing the number of ink colors for image quality improvement or increasing the number of inks of the same color for increased productivity, it is advantageous that a plurality of liquid supply apparatuses 1 are provided as such. In such a case, by employing a layout in which some or all of the liquid supply apparatuses 1 overlap with the liquid discharge apparatus 101 in the X direction as in the present embodiment, the installation area of the system 100 can be reduced. In the case of the present embodiment, one of the two liquid supply apparatuses 1 fits within the size of the liquid discharge apparatus 101 in the X direction. The size relationship is such that when there are two or more units, they slightly protrude from the system 100 in the X direction.

### (Liquid Container and Support Unit)

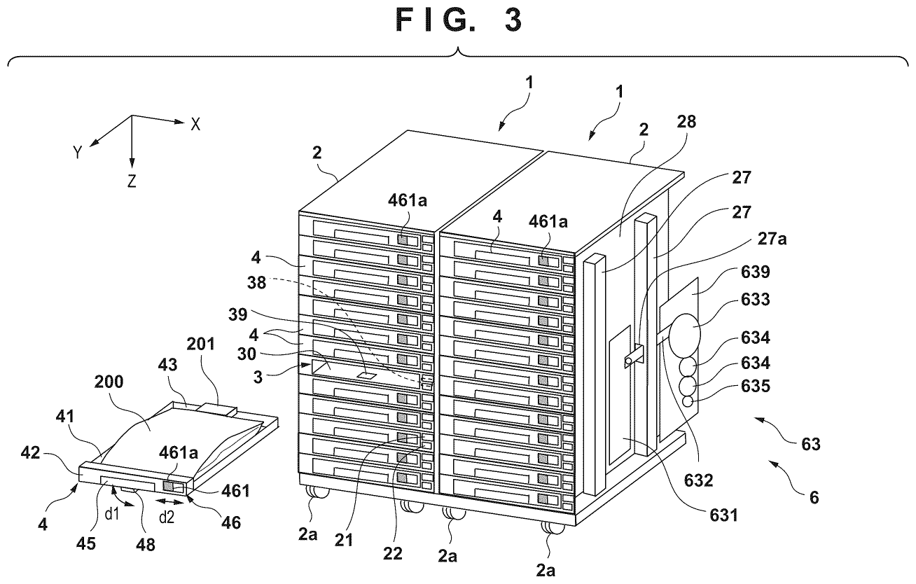

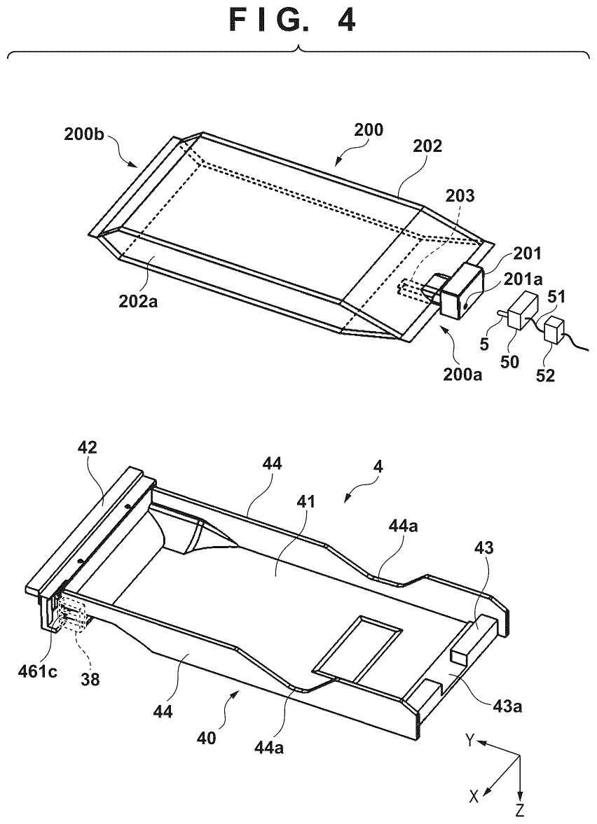

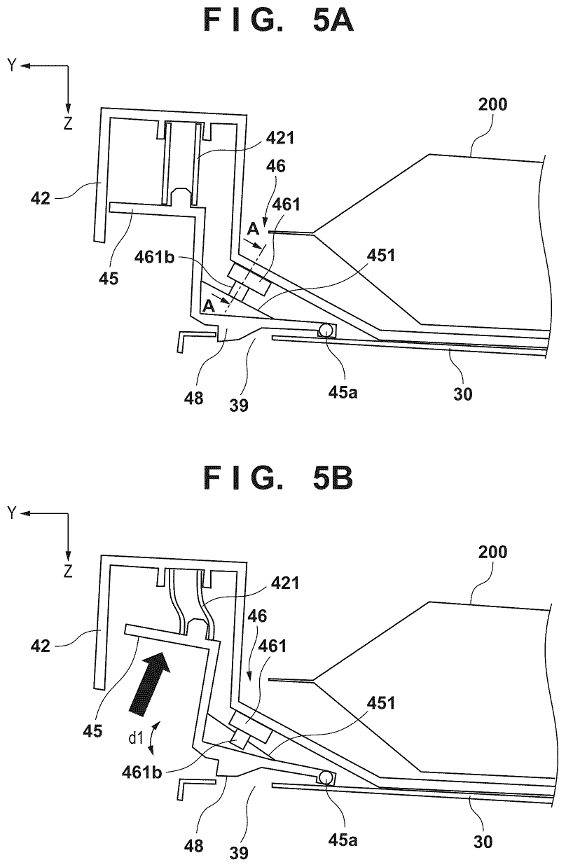

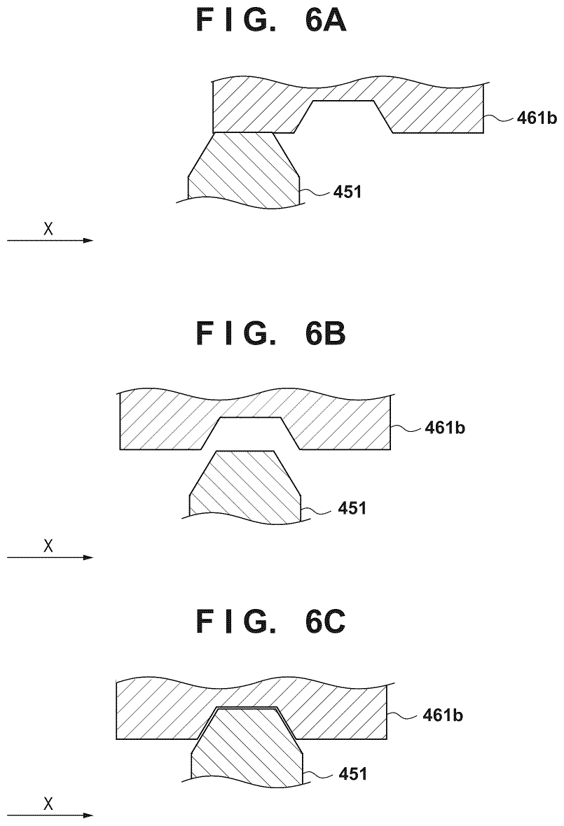

FIGS. 3 to 6 are referred to. FIG. 3 is a partially exploded perspective view of the liquid supply apparatuses 1 and illustrates a state in which one support unit 4 has been removed from a corresponding slot 3. Further, FIG. 3 illustrates a state in which a part of a side wall portion of the outer wall portion of the liquid supply apparatus 1 has been removed and an internal mechanism is exposed. FIG. 4 is a perspective view of the container 200 and the support unit 4. FIGS. 5A and 5B are explanatory views of operation of a handle 45 and a lock mechanism 46. FIGS. 6A to 6C are explanatory views of operation of the lock mechanism 46 and correspond to cross-sectional views taken along line A-A of FIG. 5A.

The container 200 includes a bag 202 formed of a flexible material. Both side surfaces of the bag 202 are provided with an inwardly-folded gusset portion 202a for increasing liquid capacity. The bag 202 is formed in a bag shape by welding respective sheets constituting the top and bottom surfaces and sheets forming the gusset portions 202a to each other, and the bag 202 forms a flexible tank for storing a liquid. When the amount of liquid remaining inside is large, the gusset portions 202a expand, and when it is small, the gusset portions 202a fold in; the shape of the bag 202 changes according to the amount of liquid stored. The material of the bag 202 is, for example, a material having a multilayered structure, such as PET. If the liquid inside has a property of reacting with air and solidifying or there is a concern that the density or the remaining amount changes due to evaporation, a layer material including an aluminum layer is advantageous as a material of the bag 202.

The container 200 includes one end portion 200a and the other end portion 200b in a lengthwise direction. While mounted in the liquid supply apparatus 1, the end portion 200a is positioned on the far side of the liquid supply apparatus 1, and the end portion 200b is positioned on the near side. The end portion 200a is provided with an outlet member 201. Regarding the outlet member 201, a supply port 201a connected with an intake port 203 in the bag 202 is formed. The liquid stored in the bag 202 flows out through the intake port 203 and the supply port 201a. A spring biased supply port on-off valve for opening and closing the supply port 201a is provided in the outlet member 201. At normal times, the supply port 201a is kept closed by the supply port on-off valve.

Regarding the container 200, the length of the side on which the outlet member 201 is provided is, for example, about 180 mm, and the length of the side (side surface) orthogonal thereto is, for example, about 400 mm. The container 200 contains, for example, a liquid of about 1.5 L. The side on which the outlet member 201 is present may be the longer side rather than the shorter side. Further, the bag 202 may be square rather than rectangular in plan view.

The body 2 includes needle-type channel forming members 5 to be inserted into the supply ports 201a on the far side of the slots 3. The channel forming member 5 is provided for each slot 3. When the channel forming member 5 is inserted into the supply port 201a and a connected state is established, the supply port on-off valve enters an open state by the channel forming member 5 being inserted. The channel forming member 5 is supported by a block-shaped support member 50 and is also connected to a tube 51. The channel forming member 5 forms a channel for the liquid stored in the bag 202 to flow to the liquid discharge apparatus 101, which is the supply destination, and the liquid that flowed to the channel forming member 5 is supplied to the liquid discharge apparatus 101 via the tube 51. An electric channel valve 52 is provided in a midway portion of the tube 51. The tube 51 can be opened and closed by the channel valve 52 being opened and closed.

The support unit 4 includes a support portion 40 for supporting the container 200 and, as a whole, has a form of a tray on which the container 200 is to be placed. The support unit 4 is displaceable in a substantially Y direction between a storage position in which the container 200 is stored in the body 2 and a removal position in which the container 200 is exposed to the outside of the body 2. Regarding FIG. 3, one support unit 4 is positioned in the removal position, and the other support units 4 are all positioned in the storage positions. In the removal position, the container 200 can be replaced, and in the storage position, the liquid stored in the container 200 can be supplied to the liquid discharge apparatus 101. In the present embodiment, the support unit 4 is separated from the slot 3 in the removal position. However, the removal position may be a position in which the end portion of the support unit 4 is held in the slot 3 and need only be a position in which the container 200 can be replaced for the support unit 4.

The support portion 40 includes a placement surface 41 on which the container 200 is to be placed, and the four sides of the placement surface 41 are defined by left and right side plates 44, a front end portion 42, and a back end portion 43. A notch portion 44a is formed in the side plate 44. A recess 43a in which the outlet member 201 is to be arranged is formed in the back end portion 43.

A user operable handle 45 is provided at the front end portion 42. In the present embodiment, the handle 45 can be rotated about a shaft 45a extending in the X direction, and the user can rotate the handle 45 in a d1 direction. The handle 45 also serves as an operation handle capable of releasing the engagement of an engaging portion 48. The handle 45 is provided with the engaging portion 48. However, the engaging portion 48 need only change in position in coordination with the handle 45, and the handle 45 and the engaging portion 48 may be provided separately.

An engaging portion 39 for engaging with the engaging portion 48 is formed in the bottom portion of a case 30 forming the slot 3. In the present embodiment, the engaging portion 48 is a convex portion, and the engaging portion 39 is a concave portion into which the engaging portion 48 is to be inserted. The support unit 4 mounted in the slot 3 and positioned in the storage position is restricted from displacing from the storage position by the engaging portion 48 and the engaging portion 39 engaging. For example, even if vibration is applied by the liquid supply apparatus 1 moving or the like, it is possible to prevent the support unit 4 from falling out of the slot 3. The handle 45 is biased toward a side of the engaged position (position of FIG. 5A) at which the engaging portion 48 and the engaging portion 39 are engaged by an elastic member 421 at all times. The elastic member 421 is, for example, a coil spring. When the user holds the handle 45 and rotates the handle 45 in a direction indicated by an arrow in FIG. 5B, the engagement between the engaging portion 48 and the engaging portion 39 is released, and the support unit 4 inserted into the slot 3 can be removed from the slot 3.

When inserting the support unit 4 into the slot 3, it is not necessary to lift and insert the support unit 4 so as to avoid the engaging portion 48 interfering with the case 30. An end surface of the engaging portion 48 on the −Y side has an inclined surface, and thus, even if the inclined surface comes in contact with the case 30, the handle 45 is naturally rotated by the load pushing the support unit 4 into the slot 3.

To prevent the support unit 4 mounted on the slot 3 from being inadvertently removed, the lock mechanism 46 for locking the support unit 4 in the storage position is provided for each slot 3. The lock mechanism 46 includes a sliding member 461 incorporated into the front end portion 42. Regarding the sliding member 461, an operation portion 461a which is a part thereof is exposed from the front end portion 42 so as to be operable by the user. The sliding member 461 is provided so as to be able to slide in a direction of an arrow d2 (X direction) between a locked position in which the rotation of the handle 45 in the d1 direction is restricted and an unlocked position in which the rotation of the handle 45 is allowed.

FIGS. 5A and 6A illustrate a state in which the sliding member 461 is positioned in the locked position. That is, the lock mechanism 46 is in a locked state. The sliding member 461 includes a contact portion 461b, and the contact portion 461b contacts a contact portion 451 provided in a rib shape on the handle 45. In the state of FIGS. 5A and 6A, the sliding member 461 and the handle 45 interfere with each other, and the handle 45 cannot be rotated in a disengagement direction due to the sliding member 461 being in the way. Therefore, the support unit 4 cannot be removed from the slot 3.

FIG. 6B illustrates a state in which the sliding member 461 is positioned in the unlocked position. That is, the lock mechanism 46 is in an unlocked state. A notch portion of the contact portion 461b and the contact portion 451 are in opposing positions. At this time, the contact portion 451 can escape into the notch portion of the contact portion 461b as illustrated in FIG. 6C, and thus, the handle 45 can be rotated in the disengagement direction as illustrated in FIG. 5B. By the user thus operating the handle 45 after sliding the sliding member 461 to the unlocked position, the support unit 4 can be drawn out of the slot 3.

A holding mechanism for holding the sliding member 461 in the unlocked position when the support unit 4 is removed from the slot 3 may be provided. It is possible to prevent the sliding member 461 from sliding unnecessarily into the locked position and interfering with mounting of the support unit 4 into the slot 3 thereafter. The elastic member 421 may be a member formed as a unit with the handle 45. Further, the sliding member 461 may be provided with a plurality of contact portions 461b. The points at which the rotation of the handle 45 is restricted will be increased, and thus, it is possible to reduce play that occurs while locked. Such a lock mechanism 46 is also applicable to various storage structures other than the liquid supply apparatus 1.

Next, the slot 3 is provided with a sensor 38 for detecting the position of the sliding member 461. The sensor 38 is provided for each slot 3 (each storage portion). The sensor 38 is, for example, an optical sensor (e.g., photo interrupter) capable of detecting a detection piece 461c of the sliding member 461. If the sliding member 461 is positioned in the locked position, the detection piece 461c will be positioned in a detection position of the sensor 38 as illustrated in FIG. 4 and thus will be detected by the sensor 38. If the sliding member 461 is positioned in the unlocked position, the detection piece 461c will not be positioned in the detection position of the sensor 38 and thus will not be detected by the sensor 38. It can thus be determined whether the position of the sliding member 461 is the locked position or the unlocked position, that is, whether the lock mechanism 46 is in a locked state or an unlocked state, based on the detection result of the sensor 38.

It is possible to coordinate the opening and closing of the channel valve 52 with the detection result of the sensor 38. For example, if the channel valve 52 is in an open state, when it is detected that the position of the sliding member 461 is in the unlocked position by the sensor 38, the channel valve 52 is immediately closed in coordination with the detection. In so doing, it is possible to prevent the support unit 4 from being drawn out from the slot 3 while the channel valve 52 is open. If the support unit 4 is drawn out from the slot 3 while the channel valve 52 is open, air may enter the tube 51 from the channel forming member 5. This causes problems such as solidification of the liquid in the tube 51 and discharge failure in the discharge head 108. When it is detected that the position of the sliding member 461 is in the unlocked position, by immediately closing the channel valve 52 according to automatic control in coordination with the detection, it is possible to avoid a situation in which air enters the tube 51.

### (Slot Inclination)

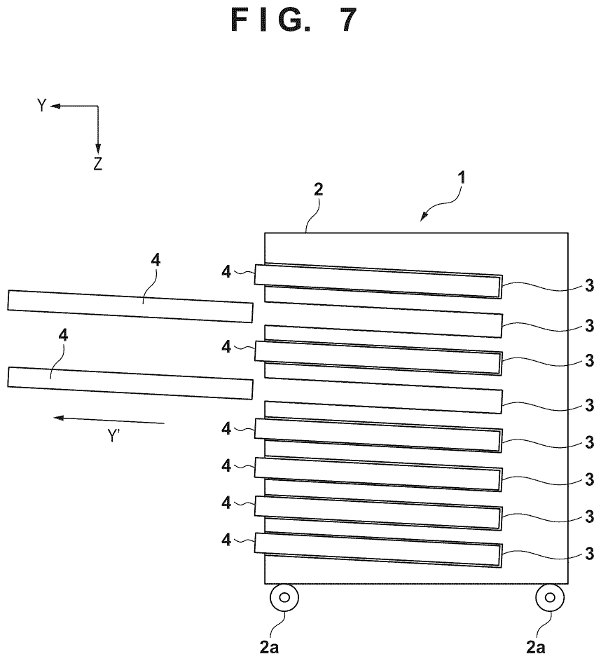

FIG. 7 is a diagram illustrating a mounting orientation and insertion and removal states of the support units 4 with respect to the slots 3.

The slot 3 of each level provided in the liquid supply apparatus 1 as illustrated in FIG. 7 is inclined and lowers toward the downward (+Z) side as it approaches the back side (far side; −Y side).

Accordingly, the support unit 4 is held in an inclined orientation in the mounted state. The effect thereof will be described later; the inclination angle is, for example, smaller than 45 degrees, in particular 10 degrees or less, with respect to the horizontal plane. In the example of FIG. 7, 3 degrees is assumed as the inclination angle.

### (Liquid Mixing Mechanism)

Various types of liquids can be stored in the container 200 and utilized for printing images, maintenance of the discharge head 108, and the like. For example, water-based ink, latex ink, and solvent (e.g., eco-solvent)-based ink can be stored in the container 200. Depending on the type of ink, a coloring material (e.g. pigment component) in the ink may settle over time. The particle size of the coloring material and the type and amount of additive material may be different for each color of the ink, and the settling speed may vary depending on the ink color. In addition, a reactive liquid that is discharged from the discharge head 108 and reacts with ink to fix the ink on the surface of the printing medium M can also be stored in the container 200. Regarding the container 200 storing a liquid having a property of components separating, it is possible to improve uniformity by appropriately mixing the stored liquid. This contributes to, for example, preventing the quality of an image to be printed from deteriorating.

In the present embodiment, the liquid supply apparatus 1 includes a mixing mechanism for mixing the liquid stored in the container 200. As an example, in the present embodiment, the bag 202 of the container 200 is deformed by being physically pressed from the outside. Accordingly, the stored liquid flows in the bag 202 and is thus mixed. Depending on the liquid stored in the container 200, some types may not require mixing. Accordingly, in the present embodiment, the slots 3 in which the mixing function is provided and the slots 3 in which the mixing function is not provided are provided. Specifically, the upper slots 3 are not provided with the mixing function, and the middle to lower slots 3 are provided with the mixing function. Of course, all the slots 3 may be provided with the mixing function.

A configuration of a pressing unit 6 which functions as the mixing mechanism will be described with reference to FIGS. 3, 8 and 9. FIGS. 8 and 9 are explanatory views of operation of the pressing unit 6 when viewing the body 2 from the side. The pressing unit 6 includes a plurality of pressing members 60, and a moving mechanism 63 common to the plurality of pressing members 60. The pressing member 60 is provided for each slot 3 and is a mixing operation unit for performing a liquid mixing operation for the corresponding container 200. The moving mechanism 63 is a driving unit for driving the pressing members 60. In the present embodiment, the moving mechanism 63 synchronously rotates each pressing member 60 with a rotation shaft 62 as the rotation center such that a pressing portion 61 provided in the pressing member 60 presses the container 200 from above or so as to reduce pressure. FIG. 8 illustrates a state in which the pressing portions 61 (and the pressing members 60) are in a pressing reduced position, and FIG. 9 illustrates a state in which the pressing portions 61 (and the pressing members 60) are in a pressing position.

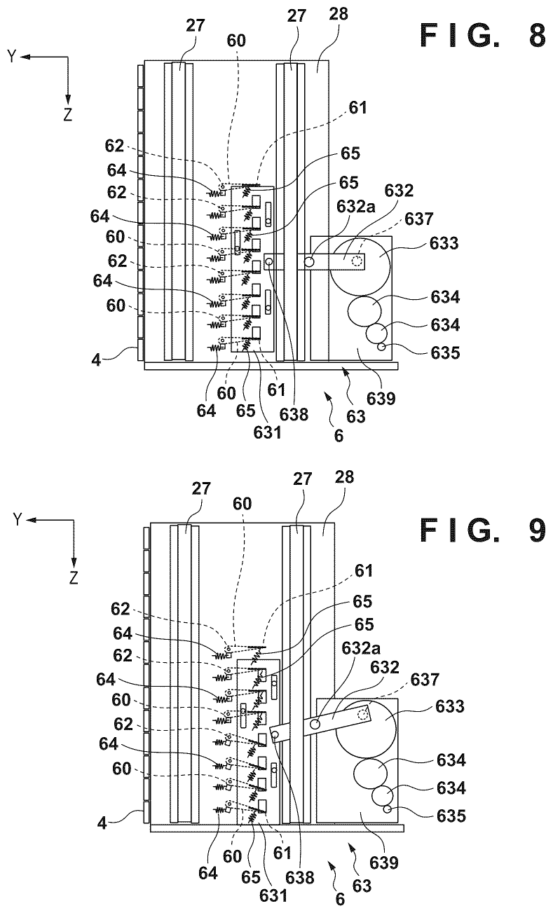

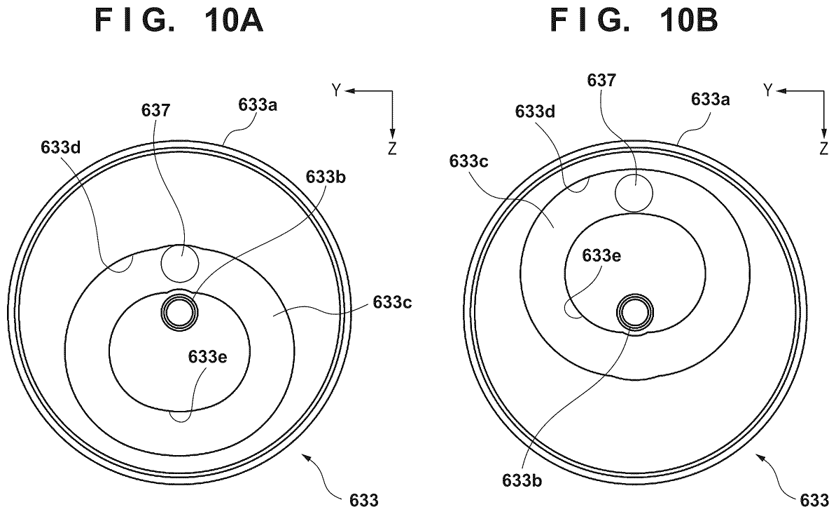

The configuration of the moving mechanism 63 will be described. The output of a motor 635 which is a driving source of the moving mechanism 63 is transmitted to a cam 633 via a plurality of gears 634. The rotation axis of each of these components is the X direction. Here, a configuration of the cam 633 will be described with reference to FIGS. 10A and 10B. FIGS. 10A and 10B are explanatory views of the cam 633, and FIG. 10B illustrates a state in which the cam 633 has rotated by 180 degrees from the state of FIG. 10A.

The cam 633 is a disc-shaped member that can rotate about a shaft 633b in the X-direction, and a gear teeth portion 633a is formed on the outer peripheral surface thereof. The gear teeth portion 633a is engaged with the gear 634, and the cam 633 is rotated by the rotation of the gear 634. A groove 633c is formed on a side surface of the cam 633, and the respective side surfaces on the outer and inner sides of the groove 633c form an outer cam surface 633d and an inner cam surface 633e. A cam follower 637 coupled with a drive transmission lever 632 is arranged in the groove 633c. The inner cam surface 633e is on the inner side of the cam follower 637 in a radial direction of the cam 633 and serves to contact the cam follower 637 when the cam 633 rotates and thus lift the cam follower 637. The outer cam surface 633d is on the outer side of the cam follower 637 in the radial direction of the cam 633 and serves to contact the cam follower 637 when the cam 633 rotates and thus lower the cam follower 637.

FIGS. 3, 8 and 9 are referred to again. When the cam follower 637 is moved up and down by the rotation of the cam 633, the drive transmission lever 632 rotates about a rotation shaft 632a. The drive transmission lever 632 is connected with a shaft portion 638 provided in a lifting member 631 so as to be rotatable, and thus, the movement of the drive transmission lever 632 is converted into a lifting operation of the lifting member 631. When the cam 633 rotates once, the cam follower 637 performs a reciprocating operation once in the Z direction, and thus, the lifting member 631 similarly performs a reciprocating lifting operation once through the drive transmission lever 632.

The plate-like lifting member 631 is attached so as to be able to move up and down in the Z direction with respect to a side plate 28 of the body 2. Further, two pillars 27 extending in the Z direction, one in the front and the other in the back, each with a U-shaped cross section, are fixed on the side plate 28. Pillars 27 are also attached to a side plate on the −X side, and the strength of the body 2 as a structure is ensured by a total of four pillars 27. This makes it possible to support the weight of a large number of containers 200.

The pillars 27 are strong but are thick, and thus, if the moving mechanism 63 is provided further on the outer side of the pillars 27 attached to the side plate 28 in the X direction, the dimension in the X direction will increase. Therefore, in the present embodiment, the driving mechanism, such as the lifting member 631 and the cam 633, are distributed to the front and back in the Y direction with one of the pillars 27 serving as a boundary. Then, the drive transmission lever 632 passes through a through-hole 27a provided in one of the pillars 27.

By doing so, it is possible to arrange the moving mechanism 63 of the pressing unit 6 so as to prevent the size of the body 2 from increasing in the X direction while ensuring strength. Furthermore, the drive transmission lever 632 is attached to a plate-shaped support member 639 for supporting the moving mechanism 63. By removing a fixing component, such as a fastening screw, most of the structure of the moving mechanism 63 can be removed as a single unit with the support member 639 to the back side of the body 2. Therefore, component replacement or the like can be easily performed by a service person. If the fixing component, such as a fastening screw, is configured to be tightened from the back side of the body 2, fastening and unfastening thereof will be easy.

The biasing forces by two springs 64 and 65 act on a respective pressing member 60. Regarding the spring 64, one end is attached to the pressing member 60, and the other end is attached to the slot 3 (case 30). Further, regarding the spring 65, one end is attached to the pressing member 60, and the other end is attached to the lifting member 631. The pressing member 60 is a movable member (in particular, rotation member) attached so as to be rotatable with respect to the slot 3 (case 30), with the rotation shaft 62 as the rotation center. The rotation shaft 62 is a shaft in a direction intersecting the moving direction (Z direction) of the pressing portion 61. The two springs 64 and 65 both bias the pressing member 60 in a direction of clockwise rotation in FIGS. 8 and 9.

When the pressing members 60 are in the pressing reduced position (FIG. 8), the lifting member 631 is in contact with the pressing members 60 and is lifting itself, and thus the biasing forces by the springs 65 are acting between the lifting member 631 and the pressing members 60. Therefore, the biasing forces of the springs 65 act only between the lifting member 631 and the pressing members 60 and do not burden the motor 635. That is, loads applied to the moving mechanism 63 at the pressing reduced position are only the biasing forces of the springs 64 and the weights of respective components themselves.

Further, when the pressing members 60 are in the pressing position (FIG. 9), the cam 633 is in a phase that is 180 degrees opposite to the pressing reduced position, and the pressing portions 61 of the pressing members 60 are in contact with the containers 200 and are pressing downward. Depending on the amount remaining in the container 200, the pressing distance of the pressing portion 61, that is, the amount of rotation of the pressing member 60 will be different. In FIG. 9, the upper four levels of the pressing members 60 each indicate a state in which they are pressing full containers 200, and the lower four levels of the pressing members 60 each indicate a state in which they are pressing deflated containers 200 with almost no remaining amount. The biasing forces of both the spring 64 and the spring 65 and the weight of each component act on the container 200. Since the springs 64 and 65 are arranged for each slot 3, even if the amount remaining in the container 200 of each slot 3 is different, it is possible to provide each container 200 with an optimal pressing force.

At this time, the biasing force of the spring 64 acts on the container 200 but does not act on the lifting member 631. The biasing force of the spring 65 acts between the container 200 with which it is contacting via the pressing member 60 and the lifting member 631. The cam 633 serves to lower the lifting member 631 downward from the container 200. The two springs 64 and 65 whose attachment positions are different and the cam 633 capable of both lifting and lowering are thus utilized to reduce the load on the moving mechanism 63 during operation.

In the pressing position, the stretch of the spring 64 and the spring 65 is small when the amount remaining in the container 200 is small and the container 200 is less deflated, and thus, the pressing force acting on the container 200 is also reduced. When the amount remaining in the container 200 is large, it is easy to receive a counterforce from the container 200 during pressing, and thus, a larger pressing force is necessary to push farther. On the contrary, when the remaining amount is small, the counterforce from the container 200 is small, and thus, even if the pressing force is small, it is easy to deform the container 200 and move the liquid inside. Therefore, the springs 64 and 65 are arranged in positions such that the more the container 200 deflates, the smaller the pressing force will be. By doing so, the biasing force of the spring does not need to be increased unnecessarily. In the present embodiment, the load applied to the pressing portion 61 is adjusted to be, for example, about 500 gf when the container 200 is full and about 300 gf when there is almost no remaining amount.

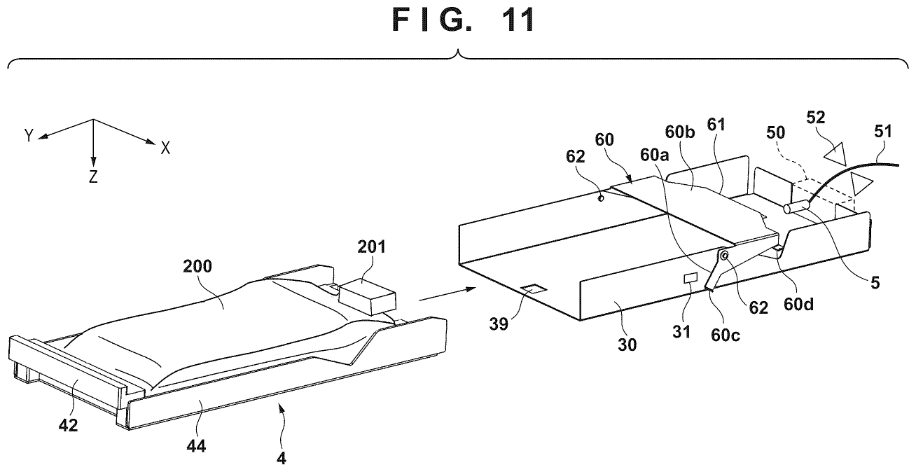

A configuration of the pressing member 60 will be described with reference to FIGS. 11 and 12. FIG. 11 is a perspective view of a case with a mixing function and a support unit in a separated state, and FIG. 12 is a perspective view of a case with a mixing function and a support unit in a mounted state.

The pressing member 60 includes a pair of side plates 60a positioned on each side portion of the case 30 in the X direction and a top plate 60b connected between the pair of side plates 60a so as to straddle the case 30 in the X direction. The pressing member 60 is supported by the case 30 via the rotation shaft 62 in each side plate 60a so as to be rotatable, and the pressing portion 61 is formed at the tip of the top plate 60b.

An engaging portion 60c with which the end portion of the spring 64 engages and a contact portion 60d with which the end portion of the spring 65 engages and which contacts the lifting member 631 when the lifting member 631 rises and causes the pressing member 60 to rotate are formed on each side plate 60a. The engaging portion 60c and the contact portion 60d are both formed in a form of a protruding piece in which they protrude in the X direction.

A remaining amount detection sensor 31 is provided on a side portion of the case 30. The remaining amount detection sensor 31 is, for example, an optical sensor. The remaining amount detection sensor 31 is a position detection sensor for detecting the position of the pressing portion 61 by detecting the side plate 60a as well as a sensor for detecting the amount remaining in the container 200 according to the result of detecting the position. Specifically, the detection position of the remaining amount detection sensor 31 is arranged at a position for detecting the side plate 60a when the container 200 deflated due to the remaining amount having decreased is pressed. The press amount at the time of pressing changing according to the degree of deflation of the container 200 is utilized. In the present embodiment, since the pressing portion 61 contacts the container 200, the position of the side plate 60a reflects the amount remaining in the container 200, and thus, the accuracy of the remaining amount detection is high. The detection position of the remaining amount detection sensor 31 is designed to detect the side plate 60a, for example, when the container 200 whose remaining amount is about 100 ml is pressed.

The pressing member 60 can be made of, for example, a metal plate material (steel plate or the like). Although it is thinner than materials such as resin but is strong, it is possible to reduce the height of the slot 3. The rotation shafts 62 of the pressing member 60 are arranged on the outer side of the container 200 in the X direction and are provided at positions at which when the container 200 is full the rotation shafts 62 and the container 200 overlap in the X direction. By these contrivances to reduce the size in the Z direction, even if the pressing member 60 is provided in the slot 3 of each level to provide a mixing function, it is possible to fit many levels of container 200 in a limited space under the housing of the system 100.

Further, the width of the pressing member 60 in the X direction is shorter in the pressing portion 61 than in the vicinity of the rotation shafts 62. This makes it possible to prevent portions other than the pressing portion 61 from contacting the container 200 when the pressing portion 61 presses the tank and thus prevent the container 200 from being damaged.

By configuring the width of the pressing member 60 in the X direction to be shorter in the pressing portion 61 than in the vicinity of the rotation shafts 62, there are the following advantages. As described above, the container 200 is provided with the gusset portions 202a on the side surfaces. The gusset portions 202a include welded portions between the flexible members and are more rigid than other portions. In order to fold the gusset portions 202a in and deflate the container 200 in response to a decrease in the amount remaining in the container 200, a suitable pressing force is necessary. In a state in which the amount remaining in the container 200 is large, the gusset portions 202a spread in the up-down direction, and there are cases where the gusset portions 202a expand outward rather than being inward. A suitable pressing force is necessary to collapse the gusset portions 202a.

By arranging the pressing portion 61 farther inward in the X direction than the gusset portions 202a, it is possible to efficiently press and deform the container 200 for mixing. The height of the gusset portion 202a is, for example, about 20 mm on both side surfaces, and by the pressing portion 61 being farther inward than the gusset portions 202a of both side surfaces, it is less susceptible to the counterforce of the gusset portions 202a and thus, it is possible to efficiently press the container 200. The pressing is performed efficiently when the width of the pressing portion 61 in the X direction is designed to be a size that fits within, for example, 10 mm or more, inward than the gusset portions 202a. This is because the effect of the counterforce of the gusset portions 202a is further decreased by the pressing portion 61 being away from the gusset portions 202a in the X direction.

As a form for minimizing the width of the pressing portion 61 in the X direction, the pressing portion 61 may take a shape that contacts the container 200 at a point, for example. However, in the case where the container 200 takes a form in which it is long in the Y direction as in the present embodiment, when a shape in which the pressing portion 61 contacts the container 200 at a point is assumed, the flowability of the liquid in the container 200 may decrease. Specifically, when the width of the pressing portion 61 in the X direction is too small, the flow of the liquid corresponding to the push by the container 200 being pressed is dispersed outward in the X direction, and thus, the amount of flow of the liquid in the Y-direction decreases accordingly.

Accordingly, for example, by configuring the width of the pressing portion 61 in the X direction to be a width that is one-third or more of the width of the bag 202 of the container 200 in the X direction, it is possible to improve the flowability of the liquid in the Y direction in the bag 202 at the time of pressing. For example, if the width of the bag 202 in the X direction is 180 mm, by configuring the width of the pressing portion 61 in the X direction to be 60 mm or more, it is possible to improve the flowability of the liquid in the Y direction in the bag 202 at the time of pressing.

Summarizing the above, if the width in the X direction is a width of 180 mm regarding the bag 202 and the gusset portions 202a whose heights are 20 mm are included regarding the gusset portions 202a, the width of the pressing portion 61 in the X direction is suitably between 60 mm to 120 mm and, in particular, may be 90 mm.

### (Mixing Operation)

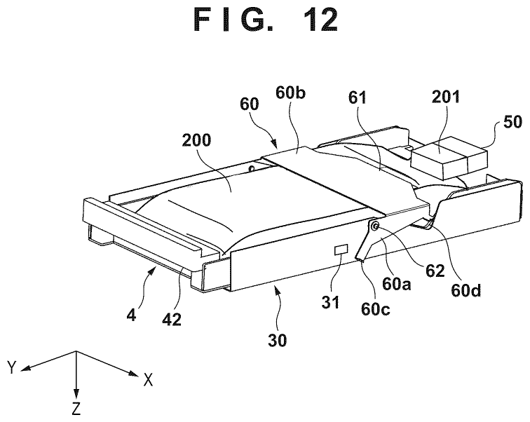

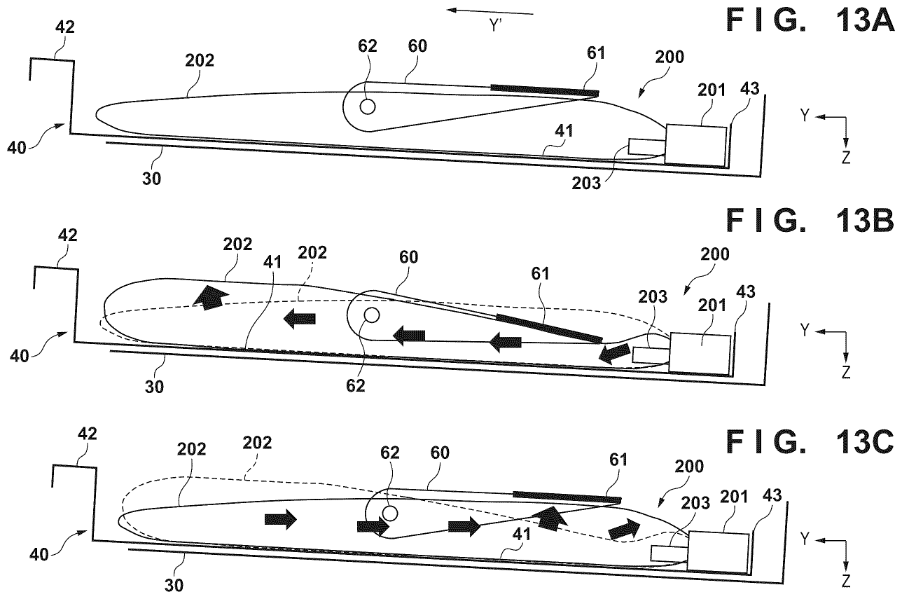

The mixing operation of the liquid in the container 200 by the pressing portion 61 pressing the container 200 will be described with reference to FIGS. 13A to 13C. FIGS. 13A to 13C are explanatory views of the mixing operation. As illustrated in FIG. 7, the mounting orientation of the support unit 4 is inclined in the present embodiment. In FIGS. 13A to 13C, a direction that is parallel to a direction of the inclination angle of the mounting orientation is set to be a Y′ direction. In the following description, the outlet member 201 side of the container 200 may be referred to as a −Y′ direction, and the side opposite thereto may be referred to as a +Y′ direction.

The arrows of FIGS. 13A to 13C represent liquid flow directions generated inside the bag 202 of the container 200.

In the case of the present embodiment, the mixing operation consists of a pressing operation and a pressing reduced operation. The pressing portion 61 is arranged so as to face the placement surface 41 of the support unit 4. The pressing portion 61 is moved back and forth between the pressing reduced position and the pressing position. This causes the bag 202 to deform, and the liquid inside is caused to flow and is thus mixed.

FIG. 13A illustrates a state in which the pressing portion 61 (and the pressing member 60) is in the pressing reduced position. In the case of the present embodiment, in the pressing reduced position, the pressing portion 61 is spaced apart from the placement surface 41 and is positioned at a height at which it does not contact the bag 202 and thus is not pressing the bag 202. Therefore, the pressing reduced position can also be referred to as a pressing released position.

The moving mechanism 63 is driven from the state of FIG. 13A, and the pressing operation is performed as illustrated in FIG. 13B. In the pressing operation, the pressing portion 61 is moved by the rotation of the pressing member 60 to a position closer to the placement surface 41 than the pressing reduced position and presses the bag 202 to the placement surface 41 side. This deforms the bag 202, and the liquid inside flows and is thus mixed.

In the present embodiment, the container 200 is mounted in the slot 3 in an orientation in which the outlet member 201 is inclined downward in the Z direction. Therefore, at the stage of FIG. 13A, the liquid in the container 200 tends to be distributed unevenly to the outlet member 201 side due to its own weight, and the bag 202 expands on the outlet member 201 side than in the central portion in the Y′ direction. The pressing portion 61 is designed to press the end portion 43 side on which the outlet member 201 is provided between the end portions 42 and 43 of the container 200. The pressing portion 61 presses the expanded portion of the bag 202 or a portion close thereto, and thus, it is possible to promote the flow of the liquid in the bag 202.

When, the liquid flows to the opposite side by the outlet member 201 side of bag 202 being pressed by the pressing portion 61, mixing can be performed efficiently. The rotation shaft 62 of the pressing member 60 is positioned on the side opposite to the outlet member 201 when viewed from the pressing portion 61 in the Y′ direction of the container 200. In the pressing operation, the direction of rotation of the pressing member 60 is a clockwise direction in FIG. 13B. When the rotation direction is thus set, a vector directed in the +Y′ direction is generated, and it becomes easy to cause the liquid to flow in the +Y′ direction. That is, it becomes easy for the liquid to flow to the side opposite to the outlet member 201 side of bag 202.

As described above, in the present embodiment, the pressing portion 61 is designed to press the end portion 43 side on which the outlet member 201 is provided between the end portions 42 and 43 of the container 200. The vicinity of the intake port 203 of the container 200 is pressed on the bag 202, and the mixing of the liquid in the vicinity thereof is particularly promoted. At the time of printing, the liquid in the container 200 flows out from a region near the intake port 203 into the tube 51. By performing mixing by pressing the vicinity of the intake port 203, it is possible to feed a liquid with a more uniform density into the tube 51.

The moving mechanism 63 is driven from the state of FIG. 13B, and the pressing reduced operation is performed as illustrated in FIG. 13C. In the pressing reduced operation, the pressing portion 61 returns to the pressing reduced position from the pressing position by the rotation of the pressing member 60. The liquid in the bag 202 flows due to the reduction of pressing and the bag 202 is returning to the original shape. Thereafter, it is possible to perform the pressing operation again.

The liquid in the bag 202 is mixed by repeating the pressing operation and the pressing reduced operation. That is, when the pressing portion 61 is in the pressing position as in FIG. 13B, the vicinity of the pressing portion 61 of the container 200 is recessed, the liquid flows in the +Y′ direction, and the side opposite to the outlet member 201 of the container 200 expands. Then, when the pressure is reduced as in FIG. 13C, the ink that flowed due to the pressure flows in the −Y′ direction due to its own weight. By repeating the pressing operation and the pressing reduced operation, the liquid moves back and forth in the Y′ direction in the bag 202 and is thus mixed. The flow of the liquid caused by the pressing reduced operation utilizes the weight thereof. By utilizing the weight thereof, a mechanism required for mixing the liquid can be made to have a simple configuration.

When repeating the mixing operation, it is possible to adjust the liquid mixing performance according to the frequency thereof. At the time of the pressing reduced operation, the liquid in the bag 202 flows at a slight delay from the rotation of the pressing member 60. The higher the liquidity of the liquid at the time of the pressing reduced operation, the higher the mixing effect. Further, when the pressing operation is performed after the liquid has flowed sufficiently, the amount of liquid stored in the bag 202 increases in the vicinity of the pressing portion 61 and the bag 202 expands, and thus, by pressing there, the mixing performance further increases. The frequency of the mixing operation is a frequency lower than, for example, several Hz, in particular, a frequency lower than 1 Hz. If the frequency of the mixing operation is too low, the total time of the mixing operation increases, and the amount of power consumed by the motor 635 may increase. Therefore, the frequency of the mixing operation, for example, may be in a range of 0.5 to 0.7 Hz, in particular 0.6 Hz.

Further, when the container 200 deflates due to a decrease in the remaining amount, the ink (liquid) flows to the −Y′ side due to its own weight and the upper side (+Y′ side) of the inclined container 200 decreases in the amount stored in that portion. Conversely, the liquid accumulates on the lower side (−Y′ side). In this state, the flow distance of the liquid in the +Y′ direction at the time of the pressing operation is shortened, and thus, the time it takes for the liquid to return at the time of the pressing reduced operation is short. Therefore, the period of the mixing operation may be shortened according to a decrease in the amount remaining in the container 200.

In the mixing operation, the pressing operation and the pressing reduced operation may be repeated with temporal intervals between the pressing reduced operation and the next pressing operation. After the pressing reduced operation, it is possible to take a long time for the liquid to flow in the bag 202 until the next pressing operation is started, and thus, it is possible to further promote the flow of liquid by its own weight.

There are several methods of adjusting the frequency of mixing operation. First is a method of utilizing a dwell angle which is a range in which the cam follower 637 that contacts the inner cam surface 633e and the outer cam surface 633d does not displace even when the cam 633 rotates. For example, the dwell angle at a position in which the cam follower 637 is at the highest point is set to 40 degrees, and the dwell angle at the lowest point is also set to 40 degrees. In particular, by reserving 40 degrees of dwell angle at the highest point, it is possible to maintain the pressing reduced position.

Further, an allocation angle, which is an angle range for raising or lowering the cam follower 637, may be large, such as, 140 degrees each. This reduces the load at the time of rotation of the cam 633 an also slowly transitions the connected pressing member 60 from the pressing state to the pressing reduced position and thus has an effect of ensuring the time for the ink to move to the vicinity of the pressing portion 61 in the meantime. Thus, the ink is sufficiently moved at the time of releasing the pressure, and thus, the mixing effect increases.

Further, another method is a method of pausing the motor 635 in the pressing reduced position. If the time corresponding to the above dwell angle of 40 degrees is implemented by stopping the motor, the dwell angle can be decreased, and thus, the allocation angle can be increased, and thereby, it is possible to reduce the load at the time of cam rotation.

A timing at which to perform the mixing operation may be any time, such as during an operation for supplying liquid to the liquid discharge apparatus 101, during a recovery operation for the discharge head 108 in the liquid discharge apparatus 101, and during a printing operation standby. The timing of the mixing operation is basically not influenced by the operation of the liquid supply apparatus 1 or the liquid discharge apparatus 101.

A mixing period in which the mixing operation is repeated may be based on time or the number of operations. For example, several 10 minutes may be set as one cycle, and the mixing operation may be repeated for only one cycle per day. Further, for example, several 10 times may be set as one cycle, and the mixing operation may be repeated for only one cycle per day. The necessary mixing period and the execution timing may be set in consideration of the velocity at which the coloring material settles in the liquid.

Referring to FIG. 7, as described above, the containers 200 and the support units 4 are inclined with respect to the horizontal plane in a state in which they are mounted in the slot 3. In terms of the liquid mixing effect, it is advantageous if the inclination angle is less than 45 degrees and more advantageous if 10 degrees or less. In the example of FIG. 7, 3 degrees is assumed as the inclination angle.

It is possible to perform mixing by pressing even if the inclination angle approaches 90 degrees, but the weight of the ink acts in a direction that resists the flow of liquid by pressing. Therefore, a stronger pressing force is required for the liquid to flow sufficiently. When the inclination angle is set to be less than 45 degrees, a vector of flow of liquid towards the −Y direction due to the weight of the liquid becomes relatively small. Regarding the amount of expansion in a portion of the bag 202 on the −Y side at the time of the pressing operation, if the inclination angle is set to be 10 degree is or less, a larger amount of expansion will be obtained with a small pressing force. If the amount of expansion of the bag 202 at the time of pressing is large, the amount of flow of the liquid inside will be large. That is, the efficiency of mixing by pressing is good.

In the present embodiment, the pressing portion 61 is positioned at a height at which it does not contact the bag 202 in the pressing reduced position, but the pressing portion 61 may contact the bag 202 and may be in a position in which it presses the bag 202 less than in the pressing position. Thus, if it is in a micro-pressing state in the pressing reduced position, it is possible to keep the upper limit position of the pressing member 60 in the Z direction low, and thus, it is possible to reduce the dimension of the liquid supply apparatus 1 in the Z direction.

Further, in the present embodiment, the pressing member 60 is provided in the case 30 of the slot 3, but a configuration may be taken in which the pressing member 60 is provided in the support unit 4. In this case, a configuration that allows driving transmission between the moving mechanism 63 and the pressing member 60 when the support unit 4 is mounted to the slot 3 need only be added.

Further, in the present embodiment, a configuration in which the container 200 is pressed by the pressing portion 61 has been described; however, for example, a configuration in which the container 200 is deformed by repeating compressed air pressing and stopping may be taken. Further, the container 200 may be deformed by the pressurizing and depressurizing the space around the container 200.

### (Display Apparatus)

A display apparatus provided in the liquid supply apparatus 1 will be described with reference to FIGS. 3 and 14A. FIG. 14A is a front view of the liquid supply apparatus 1. In the body 2, a status display unit 21 and a type display unit 22 are provided for each slot 3 (for each storage portion). The status display unit 21 and the type display unit 22 are arranged on the outer wall portion 2b and adjacent to the opening of the corresponding slot 3.

In the present embodiment, the status display unit 21 is an electronic display and performs notification related to the status of the container 200 mounted in the corresponding slot 3. Specifically, the status display unit 21 is configured by two light emitting elements 21a and 21b. The light emitting elements 21a and 21b each are, for example, an LED whose light color is different. The light emitting elements 21a and 21b each are independently driven, and driving modes such as on, flashing, and off can be switched. The state of the corresponding container 200 can be communicated to the user, using a combination (e.g., on and flashing, on and off, flashing and on, etc.) of driving modes.

The state of the container 200 to be communicated to the user is, for example, the remaining amount of liquid of the container 200. An amount of consumption (amount of discharge) of liquid stored in the container 200 can be estimated from the discharge control amount of the discharge head 108, and the remaining amount of liquid of the container 200 can be estimated from the estimated consumption amount. It is also possible to detect the remaining amount of liquid of the container 200 by the remaining amount detection sensor 31. Then, the display of the status display unit 21 corresponding to a respective slot 3 can be changed based on the remaining amount of liquid of the container 200 stored in that slot 3. Specifically, for example, when the remaining amount is less than a threshold, one of the two light emitting elements 21a and 21b is caused to flash. This makes it possible to notify the user of a timing for replacing the container 200, and thus, it is possible to prompt the preparation of the container 200 with a full liquid.

The type display unit 22 displays information on the type of liquid assigned to the corresponding slot 3. The type display unit 22 may be an electronic display but in the case of the present embodiment is a non-electronic display and is a sheet (color label) or a plate material, such as plastic or paper colored in the color of liquid as the type of liquid. With the type display unit 22, the user can visually understand the container 200 storing which type of liquid is to be mounted in which slot 3.

In the present embodiment, an opening of the slot 3 and the status display unit 21 corresponding to that slot 3 are arranged so as to be aligned in the X direction on the outer wall portion 2b. Further, an opening of the slot 3 and the type display unit 22 corresponding to that slot 3 are arranged so as to be aligned in the X direction on the outer wall portion 2b. Since the status display unit 21 and the type display unit 22 are not present between the slots 3 adjacent in the Z direction, it is possible to decrease the space between the slots 3 adjacent in the Z direction. Therefore, it reduces the height of the liquid supply apparatus 1, and thus, downsizing can be achieved.

The type display unit 22 is arranged on the status display unit 21 side in the X direction with respect to the corresponding slot 3. In other words, a pair of the status display unit 21 and the type display unit 22 corresponding to a respective slots 3 are arranged collectively in a region of an end portion of the outer wall portion 2b on the X direction side with respect to the opening of the slot 3. The side portion of the body 2 in the −X direction can be configured to be thin, and thus, it is possible to achieve downsizing of the liquid supply apparatus 1. Since the status display unit 21 and the type display unit 22 are positioned on the side opposite to the liquid discharge apparatus 101 in the X direction, it is possible to prevent the visibility of the display from being reduced due to the presence of the liquid discharge apparatus 101.

Moreover, in the present embodiment, a pair of the status display unit 21 and the type display unit 22 are arranged on the +X direction side of the slot 3, and as described above, the moving mechanism 63 is arranged on the side portion of the body 2 in the +X direction. In a front view of the outer wall portion 2b, the moving mechanism 63 is arranged at a position behind the space in which the pair of the status display unit 21 and the type display unit 22 are arranged.

Furthermore, the arrangement is such that the same pairs of the status display unit 21 and the type display unit 22 are aligned in the Z direction. By having such components concentrate on the side portion of the body 2 in the +X direction and each overlap in the X direction, the side portion of the body 2 in the −X direction can be configured to be thin. It is possible to achieve downsizing of the liquid supply apparatus 1 as a whole.

Furthermore, the operation portion 461a of the lock mechanism 46 is also arranged at the end portion of the support unit 4 in the +X direction and is arranged so as to be adjacent to the status display unit 21 and the type display unit 22 and aligned therewith in the X direction. By aggregating the components related to operations by the user and display to the user on the +X-direction end portion of the outer wall portion 2b forming the front surface of the body 2, usability can be improved. In the present embodiment, the operation portion 461a is arranged so as to be adjacent to the status display unit 21 and the type display unit 22 but is not limited thereto. For example, when the status display unit 21 and the type display unit 22 are arranged so to be shifted from each other, the operation portion 461a may be arranged so as to be adjacent to either one.

The sensor 38 for detecting the position of the sliding member 461 is positioned behind the space in which the pair of the status display unit 21 and the type display unit 22 are arranged. By providing the lock mechanism 46 itself on the support unit 4 and arranging the sensor 38, which is relatively small in size, on the +X direction side outside the support unit 4, it is possible to downsize the liquid supply apparatus 1.

As an example of the arrangement of the operation portion 461a, an example of FIG. 14B can also be employed. The difference between FIG. 14A and FIG. 14B is mainly the position of the operation portion 461a, and the operation portion 461a is arranged on the outer wall portion 2b of the body 2 rather than in the support unit 4. That is, in a state in which the support unit 4 is removed from the slot 3, the operation portion 461a remains on the body 2 side. By doing so, it is possible to simplify the configuration of the support unit 4. In the example of FIG. 14B, the operation portion 461a is arranged so as to be aligned in the X direction with the type display unit 22 and is arranged so as to be aligned in the Z direction with the status display unit 21.

### <Control Circuit>

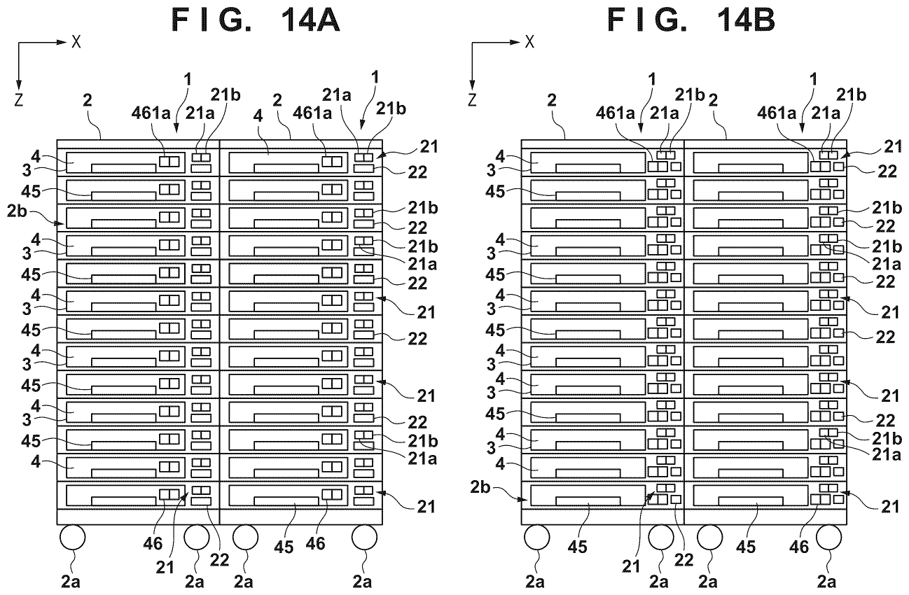

A configuration of a control circuit of the system 100 will be described with reference to FIG. 15. FIG. 15 is a block diagram of the control circuit of the system 100. A main control unit 317 controls the entire system 100 in response to instructions from a host computer 918 and the operation panel 110. A control unit 915 controls the liquid discharge apparatus 101 based on instructions of the main control unit 317, and a control unit 916 controls the liquid supply apparatus 1 based on instructions of the main control unit 317. The main control unit 917 and the control units 915 and 916 include, for example, at least one processor, at least one storage device, and at least one input/output interface. The storage device is, for example, a semiconductor memory, such as a RAM and a ROM. The input/output interface performs input/output of signals between the processor and external devices (e.g., sensors and motors).

A discharge control unit 901 performs control of the discharge head 108, in particular control for discharging of a liquid. A conveyance motor 902 drives the conveyance unit 106. A carriage motor 903 is a driving source of the moving mechanism of a carriage (not illustrated). A winding motor 904 is a driving source of the winding unit 105. A cutter motor 905 is a driving source of a cutter (not illustrated) for cutting the printing medium M on which an image has been printed. A recovery motor 906 is a driving source of the recovery unit 109. These are controlled by the control unit 915.

A clock unit 909 is a counter for outputting a result of counting elapsed time to the control unit 916. When the mixing period is managed in time, it is possible to use the count result of the clock unit 909. Further, it is also possible to determine the mixing timing by using the count result of the clock unit 909. The sensor 31 and the sensor 38 detect the amount remaining in the container 200 and the position of the sliding member 461, respectively, as described above, and these detection results are obtained by the control unit 916. The motor 635 drives the moving mechanism 63, and a channel valve switching motor 913 switches the closing and releasing of the channel valve 52. A liquid supply motor 911 is a driving source for sending liquid from the container 200 to the liquid discharge apparatus 101, and the liquid is sucked from the container 200 by the liquid supply motor 911 being driven while the channel valve 52 is in the open state and is supplied to the liquid discharge apparatus 101. These motors are controlled by the control unit 916. The driving of the status display unit 21 is also controlled by the control unit 916.

### <Example of Processing of Control Circuit>

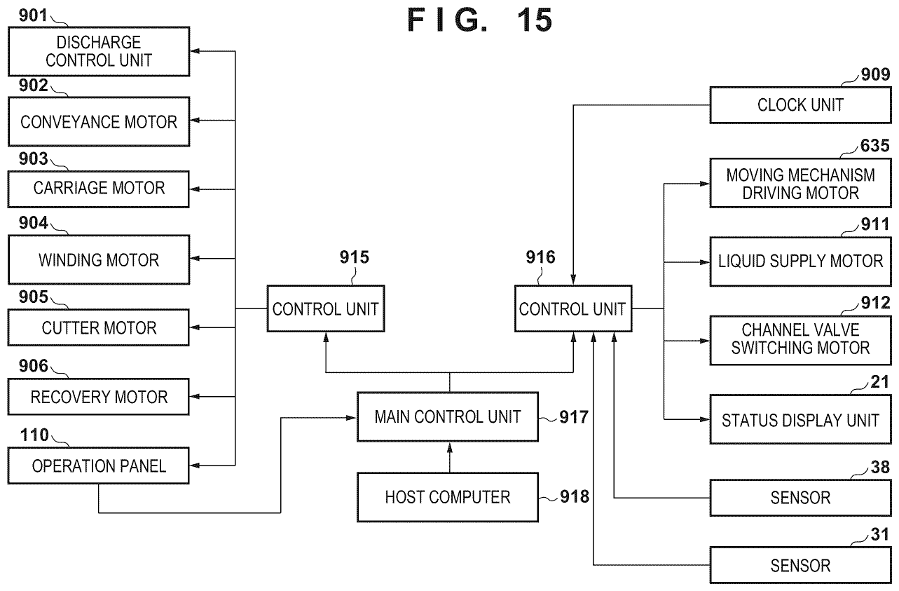

An example of processing to be executed by the control unit 916 regarding the mixing operation will be described. FIG. 16A is a flowchart thereof. In step S1, it is determined whether a mixing start condition (pressing start condition) is satisfied. When the mixing start condition is satisfied, the processing proceeds to step S2. The mixing start condition is, for example, an arrival of a predetermined time of the day, when an elapsed time from the end of the previous mixing operation has reached a predetermined length of time, or when the user instructs mixing via the operation panel 110, or the like. At the time of initial installation of the liquid supply apparatus 1 or when the container 200 has been replaced, there are cases where the coloring material has settled, and thus, it may be made easy for the start condition to be satisfied. For example, if the mixing operation is to be performed only one cycle per day, two cycles may be performed per day.

In step S2, the mixing operation is started. Specifically, the moving mechanism 63 is driven by driving the motor 635 to rotate the pressing member 60. The pressing portion 61 moves back and forth between the pressing reduced position and the pressing position, and the pressing operation and the pressing reduced operation are thus repeated.

In step S3, it is determined whether an end condition is satisfied. When the end condition is satisfied, the processing proceeds to step S4. The end condition is, for example, elapsing of a predetermined length of time, when the number of operations of the mixing operation has reached a predetermined number of times, when the amount of rotation of the motor 635 has reached a predetermined amount of rotation, or when the user instructs the end of mixing via the operation panel 110 or the like. At the time of initial installation of the liquid supply apparatus 1 or when the container 200 has been replaced, it may be made difficult for the end condition to be satisfied. For example, if the end condition is the elapsation of a predetermined length of time, the predetermined length of time may be increased. In the case it is set to when the number of operations of the mixing operation has reached a predetermined number of times, the predetermined number of times may be increased.

In step S4, the mixing operation is ended. Specifically, the driving of the motor 635 is stopped to stop the moving mechanism 63. The motor 635 may be stopped when the pressing portion 61 (pressing member 60) is in the pressing reduced position, and in this case, even if the support unit 4 is inserted or removed thereafter, the pressing member 60 will not interfere. With the above, the processing ends.

FIG. 16B illustrates an example of processing related to unlocking of the lock mechanism 46. In step S11, a detection result of the sensor 38 of each slot 3 is obtained, and it is determined whether there is a support unit 4 for which the lock mechanism 46 has been unlocked. If there is a support unit 4 for which the lock mechanism 46 has been unlocked, the processing proceeds to step S12. In step S12, the channel valve switching motor 912 of the channel valve 52 corresponding to the support unit 4 that has been unlocked is driven, and the channel valve 52 enters a closed state. In step S13, regardless of whether the mixing operation is in progress, the motor 635 is driven and the pressing portion 61 (pressing member 60) is moved to the pressing reduced position. With the above, the processing ends. Even if the support unit 4 is removed from the slot 3, it is possible to prevent air from entering the tube 51 and also prevent the pressing member 60 from interfering with the insertion and removal of the support unit 4.

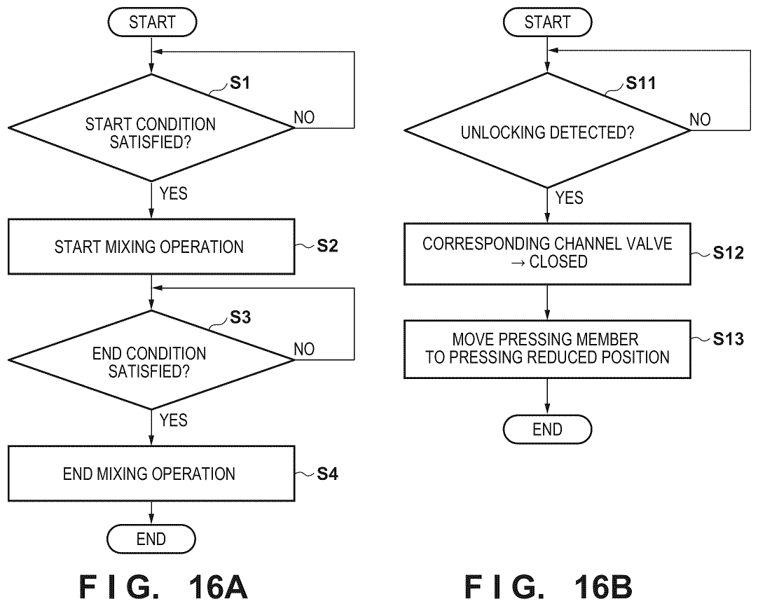

FIG. 17A illustrates an example of changing the operation setting of the mixing operation according to a change condition being satisfied, in particular illustrates an example of processing based on a detection result of the remaining amount of liquid of the container 200 as the change condition. This processing example can be performed in parallel during the mixing operation.

In step S21, the detection result of the sensor 31 of each slot 3 is obtained, and it is determined whether there is a container 200 whose remaining amount is low (container 200 for which the side plate 60a of the pressing member 60 has been detected by the sensor 31). If there is a container 200 whose remaining amount is low, the processing proceeds to step S22.

In step S22, the operation setting for the mixing operation of the next cycle is changed. For example, the mixing period is decreased. If the mixing period is based on time, the time is decreased. If the mixing period is based on the number of operations, the number of operation is decreased. Further, for example, the period of the mixing operation is decreased. Further, for example, an interval between the pressing reduced operation and the next pressing operation is decreased.

Further, for example, the mixing start condition for which determination is performed in step S1 (pressing start condition) is changed so that the frequency is reduced. Specifically, if one cycle of mixing operation had been performed at a frequency of once a day, one cycle of mixing operation may be performed at a frequency of twice a day. In the present embodiment, since the moving mechanism 63 is shared by all the pressing members 60, the change to the operation setting extends to the mixing operation of all the containers 200. If the remaining amount of some of the containers 200 is reduced, the change of the operation setting also affects the mixing operation of the containers 200 that are substantially full; however, it is assumed that the operation setting is performed with priority to the container 200 whose remaining amount has decreased.

In step S23, the display of the status display unit 21 corresponding to the container 200 whose remaining amount is low is updated to notify the user of a decrease in remaining amount. With the above, the processing ends.

### Second Embodiment

In the first embodiment, the moving mechanism 63 is shared by all the pressing members 60; however, while sharing the moving mechanism 63, a mechanism for switching transmission/interruption of the driving force for each pressing member 60 may be provided for each pressing member 60 to individually rotate each pressing member 60. Alternatively, an independent moving mechanism may be provided for each pressing member 60 to independently rotate each pressing member 60. Further, the motion of the pressing member 60 in the mixing operation may be a translational motion rather than a rotational motion.

### Third Embodiment

As an example of processing to be executed by the control unit 916 regarding the mixing operation, an example of processing of FIG. 17B may be employed instead of the example of processing of FIG. 16A. The example of the figure is an example of control for pausing the motor 635 with the pressing portion 61 (pressing member 60) in the pressing reduced position.

In step S31, it is determined whether a mixing start condition (pressing start condition) is satisfied. The processing is similar to step S1 of FIG. 16A. When the mixing start condition is satisfied, the processing proceeds to step S32.

In step S32, the mixing operation is performed once. Specifically, the motor 635 is driven from a state in which the pressing portion 61 (pressing member 60) is in the pressing reduced position and the cam 633 is rotated once and then stops. The moving mechanism 63 is driven, and the pressing portion 61 (pressing member 60) moves back and forth between the pressing reduced position and the pressing position once. The amount of rotation of the cam 633 may be managed by detection by a sensor (not illustrated).

In step S33, it is determined whether a predetermined length of time has elapsed. When the predetermined length of time has elapsed, the processing proceeds to step S34. The liquid in the container 200 flows so as to return to the pressing location of the pressing portion 61 due to elapsing of the predetermined length of time.

In step S34, it is determined whether an end condition is satisfied. The processing is similar to step S3 of FIG. 16A. If it is determined that the end condition is not satisfied, the processing returns to step S32. If it is determined that the end condition is satisfied, the processing ends.

### Fourth Embodiment

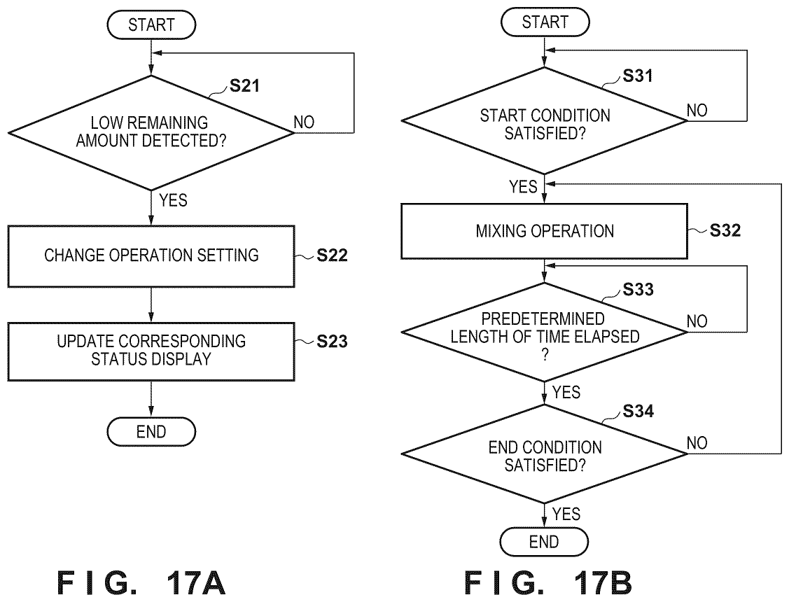

The pressing portion may be an elastic deforming portion for elastically deforming along the surface shape of the container 200. For example, the pressing portion may be constituted by a flexible sheet. FIGS. 18A and 18B are diagrams illustrating an example thereof.

FIG. 18A illustrates a state in which the pressing member 60 is positioned in the pressing reduced position. The pressing member 60 includes a base member 60A and a pressing portion 61A supported by the base member 60A.

The base member 60A corresponds to the pressing member 60 of the first embodiment and, in the present embodiment, is configured such that a sheet-like pressing portion 61A is fixed thereto. The pressing portion 61A can be formed of a flexible resin film or the like and constitutes the elastic deforming portion. The pressing portion 61A is in a substantially flat form in a state in which it is positioned in the pressing reduced position.

FIG. 18B illustrates a state in which the pressing portion 61A is positioned in the pressing position. The pressing portion 61A elastically deforms along the shape of the surface of the bag 202 and contacts the bag 202 on a wide surface. Since the pressing portion 61A curves and contacts the bag 202 over the surface, it is possible to press the bag 202 over a wide range, and thus, it is possible to improve the flowability of the liquid even if the amount remaining in the container 200 is low and the bag 202 is deflated. In particular, it is easy for the pressing portion 61A to press into a position deep in the bag 202, the flowability of the liquid improves, and the mixing performance improves.

In the container 200 whose remaining amount is low, the upper and lower surfaces of the bag 202 enters a state in which they are substantially in contact, but some space is created in the vicinity of the intake port 203. Therefore, a liquid pool 202b that is triangular when viewed in cross section may be created. By pressing the liquid pool 202b, it is possible to improve the flowability of the liquid accumulated therein. Therefore, the size of the pressing portion 61A is designed so that the pressing portion 61A reaches the liquid pool 202b. The size of the base member 60A is designed so that the base member 60A does not reach the liquid pool 202b. Regarding the pressing portion 61A, by using a material with a good sliding property such as PET, it is possible to prevent damaging the bag 202 when contacting the bag 202.

### Fifth Embodiment

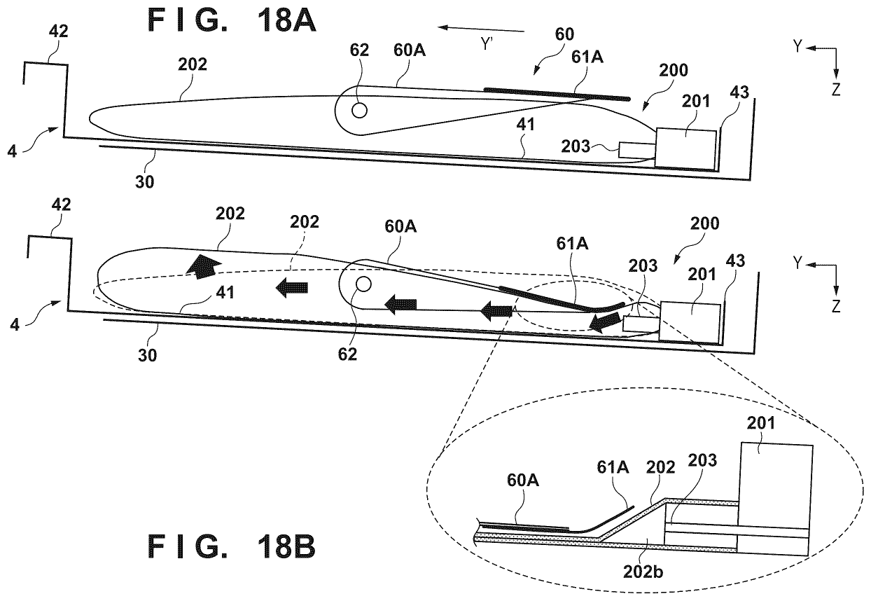

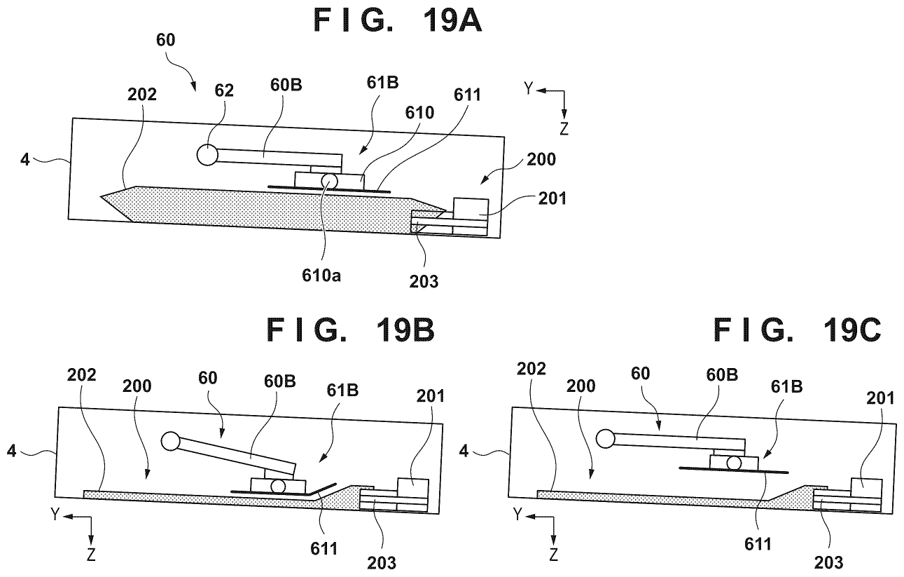

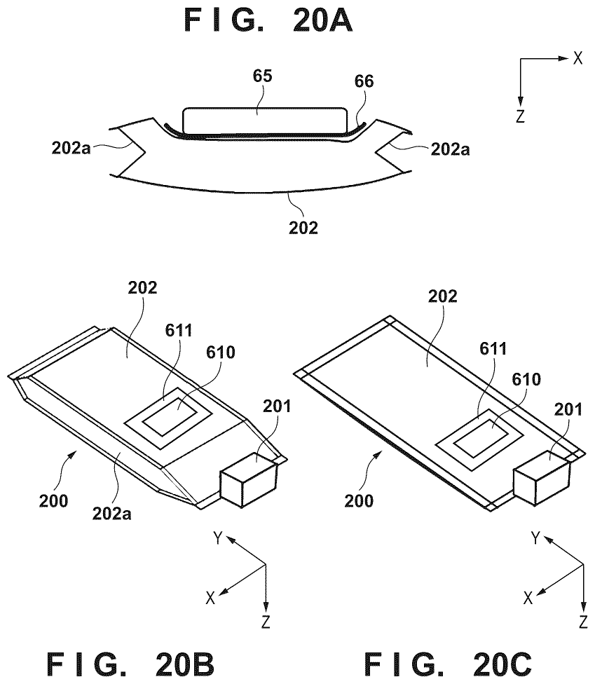

The pressing portion may be supported so as to be movable along the surface shape of the container 200. For example, the pressing portion may be configured to be supported so as to be rotatable. FIGS. 19A to 19C are diagrams illustrating an example thereof. Further, FIGS. 20A to 20C are explanatory views of a pressing location on the container 200; FIGS. 20A and 20B illustrate a case where the container 200 is substantially full, and FIG. 20C illustrates a case where the amount remaining the container 200 is small.

FIG. 19A illustrates a state in which the remaining amount of the liquid of the container 200 is substantially full as illustrated in FIG. 20A and the pressing member 60 is positioned in the pressing reduced position. The pressing member 60 includes a base member 60B and a pressing portion 61B supported by the base member 60B. The base member 60B corresponds to the pressing member 60 of the first embodiment and, in the present embodiment, supports the pressing portion 61B via a rotation shaft 610a in the X direction so as to be rotatable. The pressing portion 61B is constituted by a movable member 610 and a flexible sheet 611 supported by the movable member 610. The movable member 610 is supported by the base member 60B via the rotation shaft 610a so as to be rotatable, and the sheet 611 is a member corresponding to the pressing portion 61A of the fourth embodiment.

FIG. 19B illustrates a state in which the pressing portion 61B is positioned in the pressing position in a state in which the remaining amount of liquid of the container 200 is decreased as illustrated in FIG. 20C. The sheet 611 of the pressing portion 61B elastically deforms along the shape of the surface of the bag 202 and contacts the bag 202 on a wide surface. Further, since the movable member 610 rotates according to the shape of the surface of the bag 202, a frictional force acting on the bag 202 when the sheet 611 contacts the surface of the bag 202 is reduced, and thus, it is possible to prevent damaging the bag 202.

FIG. 19C illustrates a state in which the pressing portion 61B has returned to the pressing reduced position in a state in which the remaining amount of liquid of the container 200 has decreased. The shape of the sheet 611 is restored.

### Sixth Embodiment

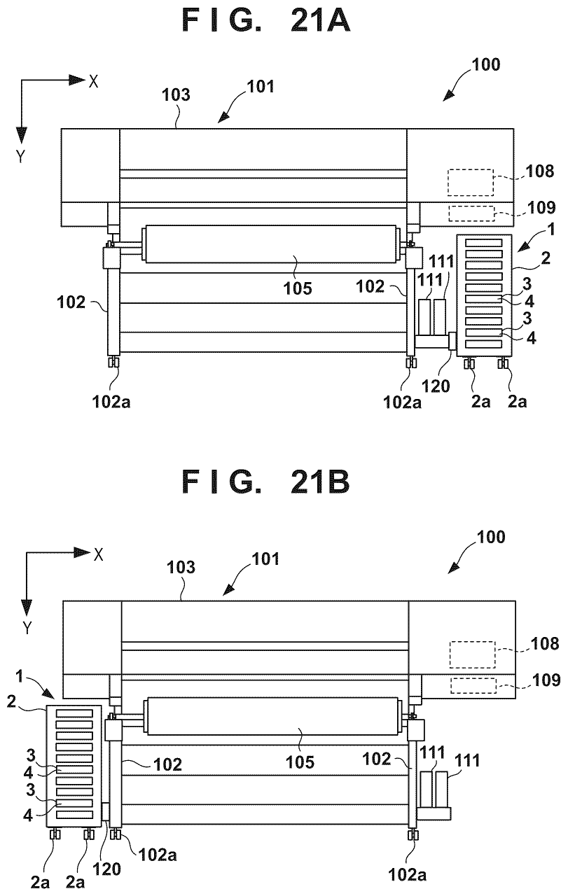

An example of another layout of the system 100 will be described. FIG. 21A is a front view of the system 100 illustrating an example of another layout. In the illustrated example, one liquid supply apparatus 1 is provided. Further, a waste liquid cartridge 111 is provided on the side of the liquid supply apparatus 1. The liquid supply apparatus 1 and the plurality of waste liquid cartridges 111 are both arranged below a portion of the body 103 that protrudes to the +X side (portion in which the recovery unit 109 is incorporated) and fit in a range of the body 103 in the X direction.

In the example of FIG. 21B, one liquid supply apparatus 1 is provided. In this example, the liquid supply apparatus 1 is arranged below a portion of the body 103 that protrudes to the −X side. The plurality of waste liquid cartridges 111 are all arranged below a portion of the body 103 that protrudes to the +X side (portion in which the recovery unit 109 is incorporated). The examples of layout as in the sixth embodiment are applicable to the configuration of the liquid supply apparatus 1 described in the first to fifth embodiments.

### Seventh Embodiment

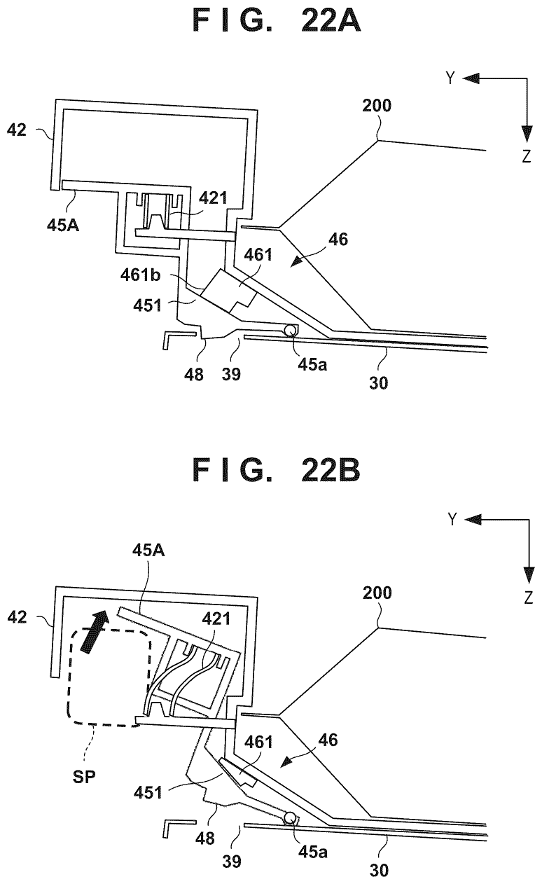

An example of another structure around the handle 45 will be described. FIGS. 22A and 22B illustrate an example thereof. Regarding a handle 45A of these figures, unlike the example of FIG. 5A and FIG. 5B, the elastic member 421 urges the handle 45A toward the disengagement side at all times rather than toward the engagement position side on which the engaging portion 48 and the engaging portion 39 engage. Therefore, when the lock mechanism 46 enters the unlocked state, the engagement between the engaging portion 48 and the engaging portion 39 is automatically released by the biasing force of the elastic member 421.

Specifically, in FIG. 22A, the lock mechanism 46 is in a locked state, the contact portion 461b contacts the contact portion 451, and the handle 45A is locked in an engaged position. The elastic member 421 is in a compressed state. When the user slides the sliding member 461 to the unlocked position, as illustrated in FIG. 22B, the handle 45A is automatically rotated about the shaft 45a by the biasing force of the elastic member 421, the engaging portion 48 is lifted, and the engagement between the engaging portion 48 and the engaging portion 39 is released. A space SP for the user to easily hold the handle 45A is formed, and the user can pull the support unit 4 out from the slot 3.

When mounting the support unit 4 in the slot 3, the user mounts the support unit 4 in the slot 3 and then slides the sliding member 461 with a slightly strong force to the locked position. With this, the contact portion 461b contacts the contact portion 451 from the side and presses down the handle 45A. The engaging portion 48 and the engaging portion 39 are engaged, the contact portion 461b contacts the contact portion 451 and enters the locked state.

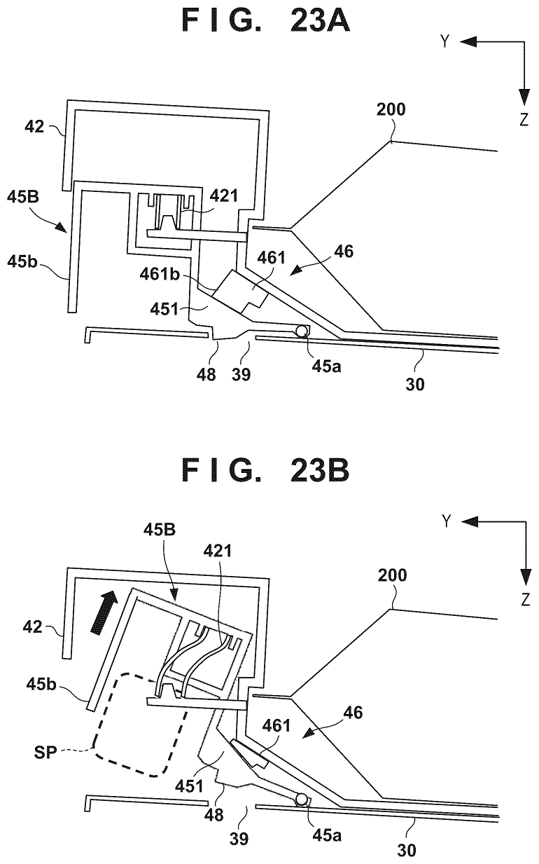

An example of FIGS. 23A and 23B is a variation of the example of FIGS. 22A and 22B. The basic configuration and operation of the example of FIGS. 23A and 23B are similar to those of the example of FIGS. 22A and 22B, but a handle 45B includes a front wall portion 45b and it is difficult for the user to hold the handle 45B. That is, since in a locked state illustrated in FIG. 23A it is difficult for the user to hold the handle 45B in the first place, it is difficult to pull out the support unit 4 from the slot 3.

When the user slides the sliding member 461 to the unlocked position, as illustrated in FIG. 23B, the handle 45B automatically is rotated about the shaft 45a by the biasing force of the elastic member 421, the engaging portion 48 is lifted, and the engagement between the engaging portion 48 and the engaging portion 39 is released. A space SP for the user to easily hold the handle 45B is formed, and the user can pull the support unit 4 out from the slot 3. As described above, in the present embodiment, in the locked state, the front wall portion 45b functions to hide the space SP from the user, and thus, in addition to the lock by the lock mechanism 46, by restricting holding of the handle 45B by the user, it is possible to prevent inadvertently pulling out the support unit 4.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-074956, filed Apr. 28, 2023 which is hereby incorporated by reference herein in its entirety.

What is claimed is:

1. A liquid storage apparatus comprising:
storage portions arranged in a first direction, each storage portion configured to store a liquid container for storing a liquid to be supplied to a discharge head;
status display units, each status display unit corresponding to one of the storage portions and configured to display a status of the liquid container stored in the storage portion; and
type display units, each type display unit corresponding to one of the storage portions and configured to display a type of liquid assigned to the storage portion,
wherein each storage portion and the corresponding status display unit are arranged so as to be aligned in a second direction that intersects the first direction, and
wherein the storage portion and the corresponding type display unit are arranged so as to be aligned in the second direction, and the type display unit is arranged on a side of the status display unit with respect to the storage portion.

2. The liquid storage apparatus according to claim 1, further comprising:
an outer wall portion in which the storage portions are opened,
wherein the status display unit is arranged in the outer wall portion so as to be aligned in the second direction with respect to the opening of the corresponding storage portion, and
wherein the type display unit is arranged in the outer wall portion so as to be aligned in the second direction with respect to the opening of the corresponding storage portion.

3. The liquid storage apparatus according to claim 1, further comprising an outer wall portion,
wherein the status display unit and the type display unit are arranged in the outer wall portion in the second direction.

4. The liquid storage apparatus according to claim 1,
wherein the status display units are arranged in the first direction, and
the type display units are arranged in the first direction.

5. The liquid storage apparatus according to claim 2, further comprising:
a mixing unit including
a mixing operation unit configured to perform a liquid mixing operation on the liquid container, and
a driving unit configured to drive the mixing operation unit,
wherein the driving unit is arranged at a position behind the status display units and the type display units in a front view of the outer wall portion.

6. The liquid storage apparatus according to claim 2, further comprising:
support units, each support unit corresponding to one of the storage portions, configured to support the liquid container, and configured to be displaceable between a storage position in which the liquid container is stored in the storage portion and a removal position in which the liquid container can be removed from the storage portion; and
lock units, each lock unit corresponding to one of the storage portions and including an operation portion configured to lock and unlock the support unit with respect to the storage position,
wherein the operation portion is adjacent to at least one of the status display unit or the type display unit.

7. The liquid storage apparatus according to claim 6,
wherein the operation portion is provided in the support unit.

8. The liquid storage apparatus according to claim 6,
wherein the operation portion is provided in the outer wall portion.

9. The liquid storage apparatus according to claim 6, further comprising:
detection units, each detection unit corresponding to one of storage portions and configured to detect whether the corresponding lock unit is in a locked state or an unlocked state.

10. The liquid storage apparatus according to claim 1,
wherein display of the status display unit changes based on a liquid remaining amount of the liquid container stored in a corresponding storage portion.

11. The liquid storage apparatus according to claim 2, further comprising:
support units, each support unit corresponding to one of the storage portions, configured to support the liquid container, and configured to be displaceable between a storage position in which the liquid container is stored in the storage portion and a removal position in which the liquid container can be removed from the storage portion; and
lock units, each lock unit corresponding to one of the storage portions,
wherein the support unit includes a first engaging portion and a handle operable by a user,
wherein the storage portion includes a second engaging portion configured to engage with the first engaging portion,
wherein by the first engaging portion and the second engaging portion engaging in the storage position, displacing of the support unit is restricted from the storage position,
wherein engagement between the first engaging portion and the second engaging portion can be released by a displacement of the handle,
wherein the lock unit changes in state between a locked state in which the displacement of the handle is restricted and an unlocked state in which the displacement of the handle is permitted.

12. The liquid storage apparatus according to claim 11,
wherein the lock unit includes a sliding member which a user can slide between a first position and a second position,
wherein in a case where the sliding member is in the first position, the locked state is established by the sliding member interfering with the handle, and
wherein in a case where the sliding member is in the second position, the unlocked state is established.

13. The liquid storage apparatus according to claim 1,
wherein the type display unit displays a color as a type of liquid.

14. The liquid storage apparatus according to claim 1,
wherein the status display unit is an electronic display, and
wherein the type display unit is a label.

15. A system comprising:
a liquid discharge apparatus configured to discharge a liquid onto a medium; and
at least one liquid storage apparatus,
wherein the at least one liquid storage apparatus includes:
storage portions arranged in a first direction, each storage configured to store a liquid container for storing a liquid;
status display units, each status display unit corresponding to one of storage portions and configured to display a status of the liquid container stored in the storage portion; and
type display units, each type display unit corresponding to one of the storage portions and configured to display a type of liquid assigned to the storage portion,
wherein the storage portion and the corresponding status display unit are arranged so as to be aligned in a second direction that intersects the first direction, and
wherein the storage portion and the corresponding type display unit are arranged so as to be aligned in the second direction, and the type display unit is arranged on a side of the status display unit with respect to the storage portion.

16. The system according to claim 15, wherein
the liquid discharge apparatus includes:
a pair of stands; and
an apparatus body supported on the pair of stands,
wherein the apparatus body includes a portion protruding to an outer side of the pair of stands, and
wherein the liquid discharge apparatus is arranged adjacent to the stand and below the portion of the apparatus body.

17. The system according to claim 16, wherein the liquid discharge apparatus further includes:
a discharge unit configured to discharge a liquid; and
a recovery unit for restoring a discharge performance of the discharge unit, and
the recovery unit is arranged in the portion.

18. The system according to claim 15, further comprising a plurality of liquid storage apparatuses,
wherein the first direction is an up-down direction,
the second direction is a left-right direction, and
the liquid discharge apparatus and the plurality of liquid storage apparatuses are arranged to be aligned in the second direction.

19. The system according to claim 15, wherein
the first direction is an up-down direction,
the second direction is a left-right direction, and
the liquid discharge apparatus and the liquid storage apparatus are arranged to be aligned in the second direction, and the status display units and the type display units are positioned on a side opposite to the liquid discharge apparatus in the second direction.
